(19) United States
(12) Patent Application Publication
(10) Pub. No.: US 2014/0006555 A1
(43) Pub. Date: Jan. 2, 2014

(54) REMOTE TRANSFER OF ELECTRONIC IMAGES TO A VEHICLE

(71) Applicant: Arynga Inc., La Jolla, CA (US)

(72) Inventor: Barton Shields, Escondido, CA (US)

(21) Appl. No.: 13/923,317

(22) Filed: Jun. 20, 2013

Related U.S. Application Data
(60) Provisional application No. 61/665,307, filed on Jun. 28, 2012.
(60) Provisional application No. 61/669,107, filed on Jul. 8, 2012.
(60) Provisional application No. 61/711,719, filed on Oct. 9, 2012.
(60) Provisional application No. 61/779,026, filed on Mar. 13, 2013.

(51) Int. Cl. H04L 29/08

(52) U.S. Cl. CPC H04L 67/12
USPC 709/217

(57) ABSTRACT

Systems, methods and computer program products for transmission of data between one or more vehicles and a control apparatus (e.g., server or other computing device). In particular, the invention relates to systems, methods and computer program products for over-the-air transmission of electronic images (EIs) between one or more vehicles and a control sub-system. The inventions also relates to a standardized methodology and system for implementation of remote EI updates.

### CROSS-REFERENCE TO RELATED APPLICATIONS

This application claims priority under 35 U.S.C. §119(e) to co-pending U.S. Provisional Patent Application Ser. No. 61/665,307, filed Jun. 28, 2012, entitled REMOTE TRANSFER OF ELECTRONIC IMAGES TO A VEHICLE, the content of which is hereby incorporated by reference herein in its entirety for all purposes. This application claims priority under 35 U.S.C. §119(e) to co-pending U.S. Provisional Patent Application Ser. No. 61/669,107, filed Jul. 8, 2012, entitled REMOTE TRANSFER OF ELECTRONIC IMAGES TO A VEHICLE, the content of which is hereby incorporated by reference herein in its entirety for all purposes. This application claims priority under 35 U.S.C. §119(e) to co-pending U.S. Provisional Patent Application Ser. No. 61/711,719, filed Oct. 9, 2012, entitled REMOTE TRANSFER OF ELECTRONIC IMAGES TO A VEHICLE, the content of which is hereby incorporated by reference herein in its entirety for all purposes. This application claims priority under 35 U.S.C. §119(e) to co-pending U.S. Provisional Patent Application Ser. No. 61/779,026, filed Mar. 13, 2013, entitled REMOTE TRANSFER OF ELECTRONIC IMAGES TO A VEHICLE, the content of which is hereby incorporated by reference herein in its entirety for all purposes.

### FIELD OF THE INVENTION

The invention relates generally to systems, methods and computer program products for transmission of data between one or more vehicles and a control apparatus. In particular, the invention relates to systems and methods for over-the-air transmission of electronic images (EIs) between one or more vehicles and a control sub-system. The inventions also relates to a standardized methodology and system for implementation of remote EI updates.

### BACKGROUND OF THE INVENTION

Current methodologies for updating electronic images (EIs) in the automotive industry may be inefficient, ineffective, inconvenient and infrequent. Accordingly, a solution may be needed that provides for greater efficiency, effectiveness, convenience and frequency in relation to updating EIs.

### SUMMARY OF THE INVENTION

In accordance with the present invention, one or more methods, systems, apparatus and computer program products comprising a computer usable medium having a computer readable program code embodied therein that may be adapted to be executed to implement a method for transmitting one or more electronic images (EIs) to one or more vehicles may be described. The method, system and computer program product may provide for identifying an EI for a particular vehicle at a server and causing the transmission of the EI to the vehicle. The transmission of the EI may occur over one or more various communication pathways, including satellite, radio frequency, Internet, local area network or other technologies. Moreover, the EI may transmit through various components before reaching the vehicle.

Upon receiving some or all of the EI, the vehicle determines if the full EI was received. If the transmission was incomplete, the vehicle causes the retransmission of the entire EI or the remaining portion of the EI. If the transmission was complete, the vehicle updates equipment on the vehicle with the EI. Finally, a confirmation of the update may be sent to the server.

### BRIEF DESCRIPTION OF THE DRAWINGS

The present application may be more fully appreciated in connection with the following detailed description taken in conjunction with the accompanying drawings.

FIGS. 1-10 illustrate various aspects associated with management of data transfer.

FIG. 11 illustrates a block diagram depicting a system for transmission of an electronic image (EI) to a vehicle in accordance with at least one embodiment of the invention.

FIG. 12a illustrates a block diagram depicting another system for transmission of an electronic image (EI) to a vehicle in accordance with at least one embodiment of the invention.

FIG. 12b illustrates a logical connection between the cloud and the vehicle.

FIG. 13 illustrates a block diagram depicting another system for transmission of an electronic image (EI) to a vehicle in accordance with at least one embodiment of the invention.

FIG. 14 illustrates a block diagram depicting a system for transmission of an electronic image (EI) to a vehicle in accordance with at least one embodiment of the invention.

FIG. 15 illustrates a process flow diagram detailing a process for transmitting an electronic image (EI) to a vehicle in accordance with at least one embodiment of the invention.

FIG. 16 illustrates a block diagram depicting system architecture in accordance with at least one embodiment of the invention.

FIG. 17 illustrates a block diagram depicting a system for transmission of an electronic image (EI) to a vehicle using a smart phone in accordance with at least one embodiment of the invention.

FIG. 18 depicts an ECU Release Package Object.

FIG. 19 depicts a Vehicle Cluster Release Package Object.

FIG. 20 depicts a Vehicle Release Package Object.

FIG. 21 depicts an OEM cloud server and database architecture.

FIG. 22 depicts several components within the vehicle.

FIGS. 23-27 depict various process flows relating to various aspects.

FIGS. 28A-B illustrate a cloud-based system in accordance with various aspects of the invention.

### DETAILED DESCRIPTION OF THE INVENTION

Various aspects of the invention may be described below. It should be apparent that the teachings herein may be embodied in a wide variety of forms and that any specific structure, function, or both, being disclosed herein may be merely representative. Based on the teachings herein one skilled in the art should appreciate that any aspect disclosed may be implemented independently of any other aspects and that two or more of these aspects may be combined in various ways. For example, a system may be implemented or a method may be practiced using any number of the aspects set forth herein.

### Overview

Aspects and features of the invention may be designed to operate on computer systems, servers, and/or other like devices. While the details of the embodiments of the invention may vary and still be within the scope of the claimed invention, one of skill in the art will appreciate that the figures described herein may be not intended to suggest any limitation as to the scope of use or functionality of the inventive aspects. Neither should the figures and there description be interpreted as having any dependency or requirement relating to any one or combination of components illustrated in those figures.

Certain aspects of the invention provide automotive OEMs and Tier 1 suppliers (Tier 1) with a seamless and customizable solution for remotely maintaining and updating all electronic images (EIs) residing in Electronic Control Units (ECUs). As used herein, an EI may be defined to be any unique sequence of bits that may be logically separated for a specific use within an embedded device (e.g., an ECU). Examples of EIs include executable images, script files, configuration data, PLD executable images, html files, and other related types of executable and/or data files. One of skill in the art will appreciate that the teachings herein apply to various types of data apart from the EIs listed herein.

An ECU may be a physically-distinct and self-enclosed electronic hardware component that provides some predefined set of functionality to the vehicle. As one of skill in the art can appreciate, ECUs and EIs designed and used by certain OEMs and Tier 1 may differ from ECUs and EIs designed and used by other OEMs and Tier 1. Accordingly, certain aspects of the disclosure provide for customization across various ECUs and EIs. For example, fields may be customizable in the sense that many fields may be optional so that the same functionality can be supported regardless of which fields may be active for a given OEM or Tier 1.

Aspects of the invention further provide a data transfer between a configuration server (e.g., a Vehicle Configuration Cloud Server (VCCS) operated by an OEM and/or one or more other entities) to an individual ECU for a specific vehicle. The configuration server/VCCS may hold all of the combinations of ECU release packages. The data may transfer using one or more of various networks, including the Internet, local area networks (e.g., LAN, WiLAN, Wi-Fi, Bluetooth), cellular or other over-the-air (OTA) wireless carrier pathways, satellite pathways, and/or other wired and wireless communication pathways. Additional transport pathways include the SIRIUSXM communication pathways and ONSTAR communication pathways, among other pathways that may be specific to transfer of data to and/or from a vehicle.

By way of example, a downlink pathway (e.g., one used for SIRIUSXM satellite radio) may be used to transfer one or more EIs to a vehicle. Such a satellite pathway may provide for enough bandwidth to effectively carryout the transmission over a reasonable time period and at many locations (e.g., including locations that may be out of range of other pathways). One-way satellite downloads may be accomplished using scheduled broadcasts for vehicles of a specific make, model, and year. In some instances, broadcasts may need to be repeated. Although very large downloads like those for updating maps may be better suited for update either via USB or a two-way communication method of transfer, satellite broadcasts may also be used. Thus, an intelligent arbitration scheme may be needed at the Cloud Gateway Interface (CGI) that determines the specific mechanism for downloading according to a set of preset decision criteria.

It may be contemplated that two-way and one-way communication links may be used, and that channels of various bandwidth may be used. For a nominal download case involving standard or known ECUs at the vehicle and/or standard RPs, two-way communication may be not absolutely necessary provided that sufficient verification information may be contained within the downloaded information in a manner similar to the necessary checks and balances that may be implemented for updates residing on a physical medium (e.g., USB Flash Drive, CD/DVD, or other components with memory). Two-way communication may become necessary where For example, vehicles include ECUs, other components and RPs that deviate from standard or known ECUs, other components and RPs. In such an instance, differences in data transfer may need to be carried out using a two-way communication pathway (e.g., transparently through a variety of means such as the vehicle owner's home Wi-Fi network), and that pathway may or may not require real-time transfer of data. Two-way communication may also be required where an OEM wishes to maintain a physical record of each individual vehicle, at which point a confirmation of the updates may be returned to the VCCS from the vehicle. However, such confirmation messages may be not required to occur in real time and may be indefinitely postponed until a convenient time in the future. Two-way communication may be further required where the VCCS or other component external to the vehicle processes error status information. Two-way communication pathways also permit transfer of other information from the vehicle to the VCCS or other component external to the vehicle.

In most instances (e.g., where standard or known ECUs may be involved), a one-way communication pathway like a satellite downlink may be sufficient. The data may be packaged pursuant to various standards, protocols and methodologies of those pathways. Downlink communications to a vehicle may specify various information, including a channel from which an EI may be received, the EI, instructions, and other information necessary for successful maintenance of EIs.

Whether one-way or two-way communication may be used, the EI may be downloaded to the appropriate ECU following completion and verification of the EIs download from the network. Historic transactional information may be subsequently stored within the ECU containing the Logical Vehicle Compartment (LVC) Configuration Server (CS) for future reference and upload to an external configuration server such as the OEM VCCS or a user specified Vehicle Configuration Proxy Server.

It may be further contemplated that data may be delivered from and/or to a personal computer (e.g., a smart phone or home computer connected to the vehicle and running a local “Proxy Configuration Server”), an official Configuration Server in communication with the vehicle at a dealer or other authorized location, another vehicle connected to the vehicle, a USB connected to the vehicle, or other component with memory and/or processing capabilities that may be connected to the vehicle. The data may also transfer through various components in the vehicle, including the vehicle's Vehicle Gateway Server (VGS). One of skill in the art will appreciate that connection between an OEM's VCCS and the vehicle's ECU may depend upon the OEM's implementation of the AUTOSAR standard Unified Diagnostic Service (UDS) ECU programming protocol.

In accordance with yet another aspect of the invention, transfer of data between the VCCS and the ECU can carried out in a safe, secure, reliable, and flexible manner. For example, the transfer may be safe in that no EI may be downloaded until it has been verified as the correct EI for the specific ECU subcomponent. CRC checks and other release version related compatibility checks may be used to verify the EI for the ECU. Moreover, the transfer may be secure in that the data may be sent utilizing IP Security across the Internet cloud and WiFi Protected Access across any Wi-Fi network on the vehicle-side of the data transfer. The transfer may be reliable in that data aggregation may be used, which allows for as many multiple sessions as required in order to aggregate and accurately reassemble a single Release Package of information or set of Release Packages. A Release Package (RP) may be a sequential linearly stored data object comprised of descriptive information, configuration data, executable scripts, and EIs (EIs) needed for a specific physical entity (such as an ECU) or logical entity (an entire LVC).

The transfer may be flexible in that the configuration of the record structure utilizes optional fields and/or mandatory fields as opposed to only mandatory fields in its ECU EI and RP configuration database (DB) design. Further flexibility may be available in that the transfer may occur over a variety of transport mediums between the VCCS and individual Vehicle Gateway Interfaces. A Vehicle Gateway Interface (VGI) may be a communication interface at a vehicle to external components for which all LVC Configuration Servers must interface with in order to communicate with the VCCS.

In accordance with yet another aspect, the invention may provide for a complete Configuration Management System (CMS) and delivery methodology for updating ECU EIs that provides both ends of the configuration link and a methodology enabling complete connectivity between both ends regardless of the communication pathway(s). In accordance with at least some embodiments, end-point components like an OEM VCCS and the LVC Configuration Server within the vehicle, or intermediary components, may be unaware of the pathway supplying the data. Of course, other components may be away of the pathway(s) used to deliver the data, including such other components as the VGI.

Similarly, the components may be unaware of the methodology used to transport the data (e.g., so long as the inward facing ports have been implemented to allow downloading sessions to pause and resume across a series of multiple connections). Accordingly, as data transfer technologies and methodologies evolve, the inventive solutions described herein may evolve with those technologies/methodologies. It may be contemplated that various technologies be used, including differential engine technology of Red Bends.

Attention may be now given to particular embodiments of the invention as described below. One of skill in the art will appreciate that alternative embodiments fall within the scope and spirit of the invention. One of skill in the art will further appreciate that various combinations of the aspects described above may be implemented with respect to any of the embodiments below.

### Data Transfer and Other Aspects in Certain Embodiments

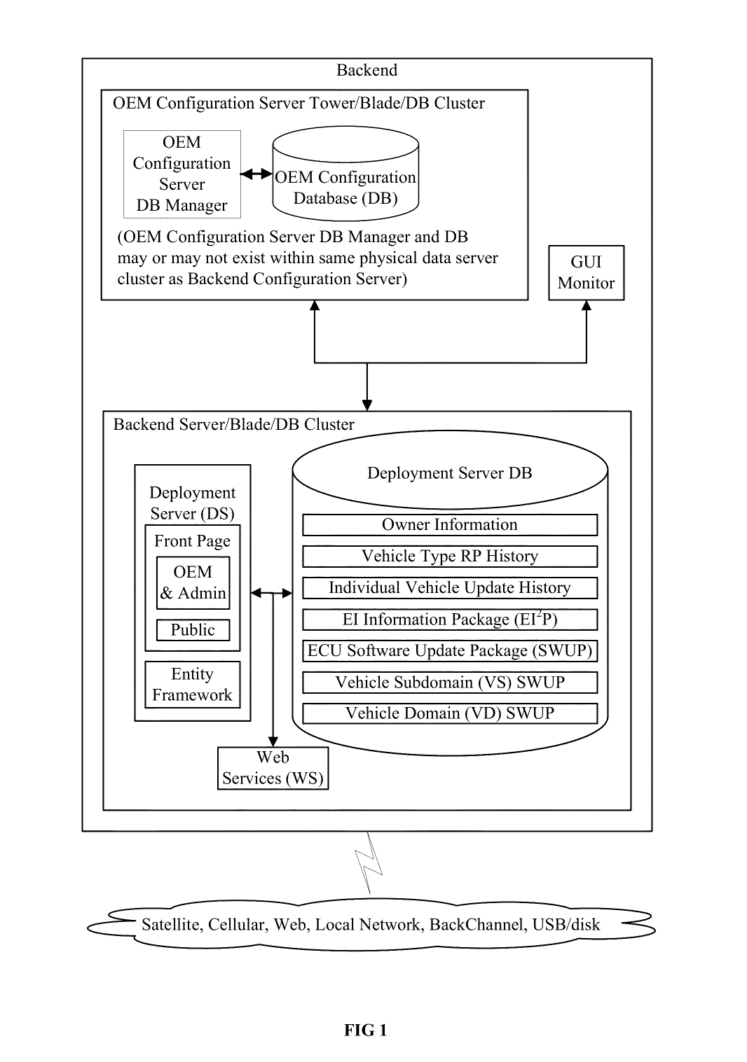

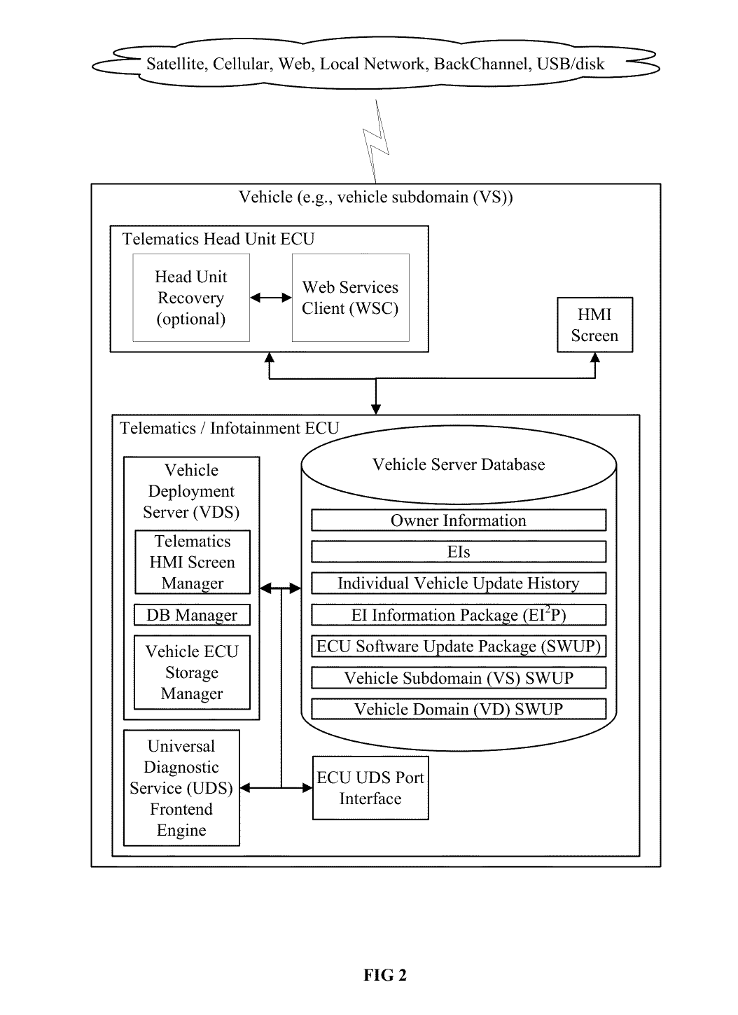

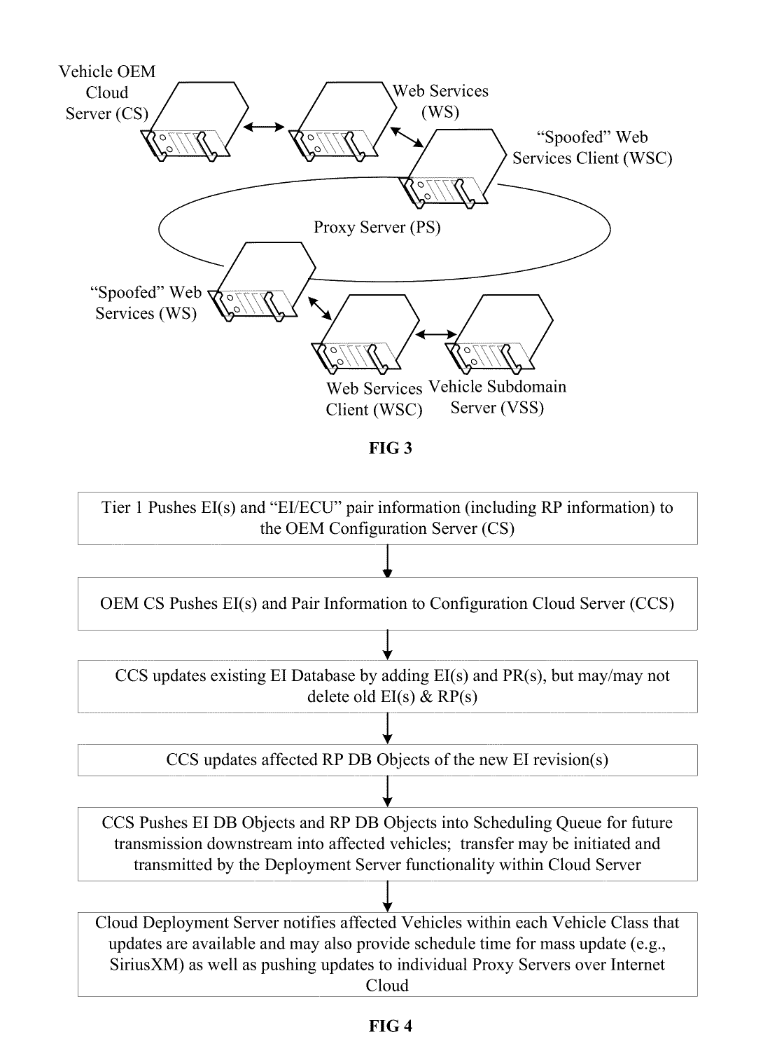

Attention may be now drawn to FIG. 1 and FIG. 2, which depicts architecture for managing and carrying out the transfer of data among various components, and illustrates various pathways for transferring data among those components. The system of FIG. 1 and FIG. 2 may be used, for example, to enable universal remote updating of EIs across the automotive OEM and Tier 1 marketplace. FIG. 3 depicts additional architecture for managing and carrying out the transfer of data among various components, and particularly shows use of a proxy server. Use of a proxy server permits indirect downloads of EIs where transmission of the EI passes through the proxy server before reaching the vehicle.

FIGS. 4-10 depict various process flows that may be carried out within the systems of FIGS. 1-3, or other systems disclosed herein.

In FIG. 4, an Electronic Image (EI) is transmitted from a Cloud Server after being encapsulated by a Release Package (RP) wrapper. Most of the time the RP will not be a “full” RP (meaning, it will not be populated with all of the contents specified within that specific RP). Rather, it will be a “Differential” RP. A Differential RP only contains those individual elements within the RP that are physically different than the immediate prior version of the same RP. Meaning, it will still have placeholders for all elements found in a “fully populated” RP. However, only those elements that are different will be populated within a Differential RP. So long as the prior version of the EI is within the vehicle's memory, all that needs to be downloaded into the vehicle are the sections of the EI that are different from the prior image. If this is something like map data or a standard operating system build where many portions do not change, the savings is potentially very large. A Difference Engine algorithm is applied to EIs as a consequence that only files beyond a certain size can justify the overhead of using such an algorithm.

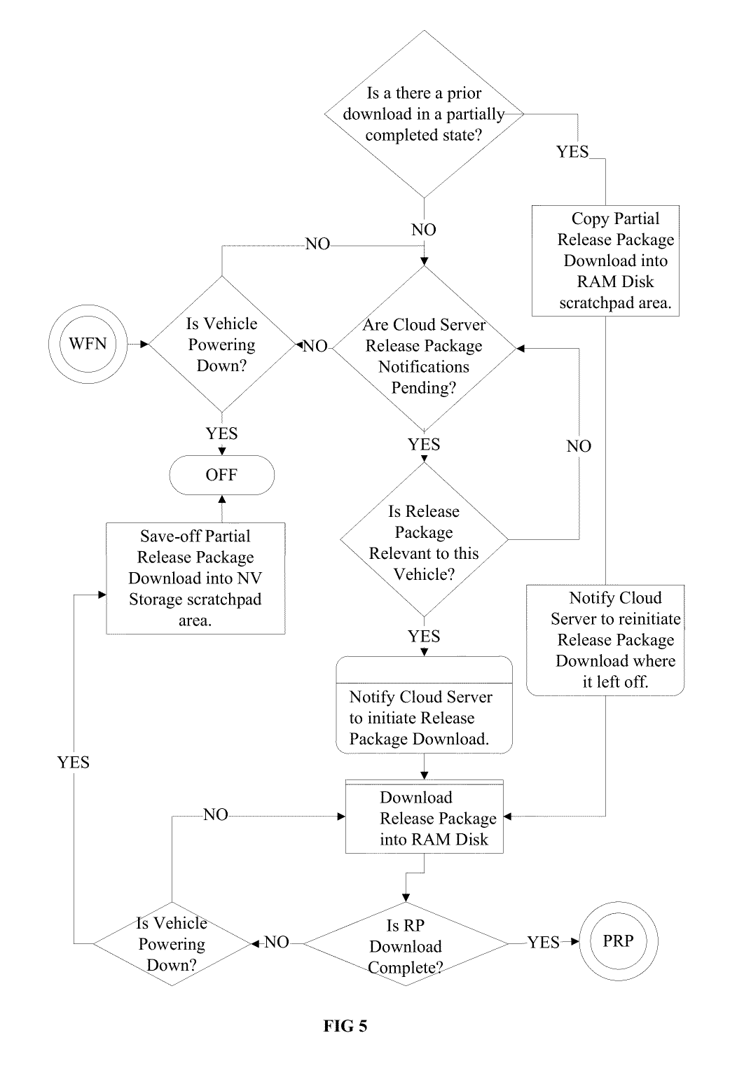

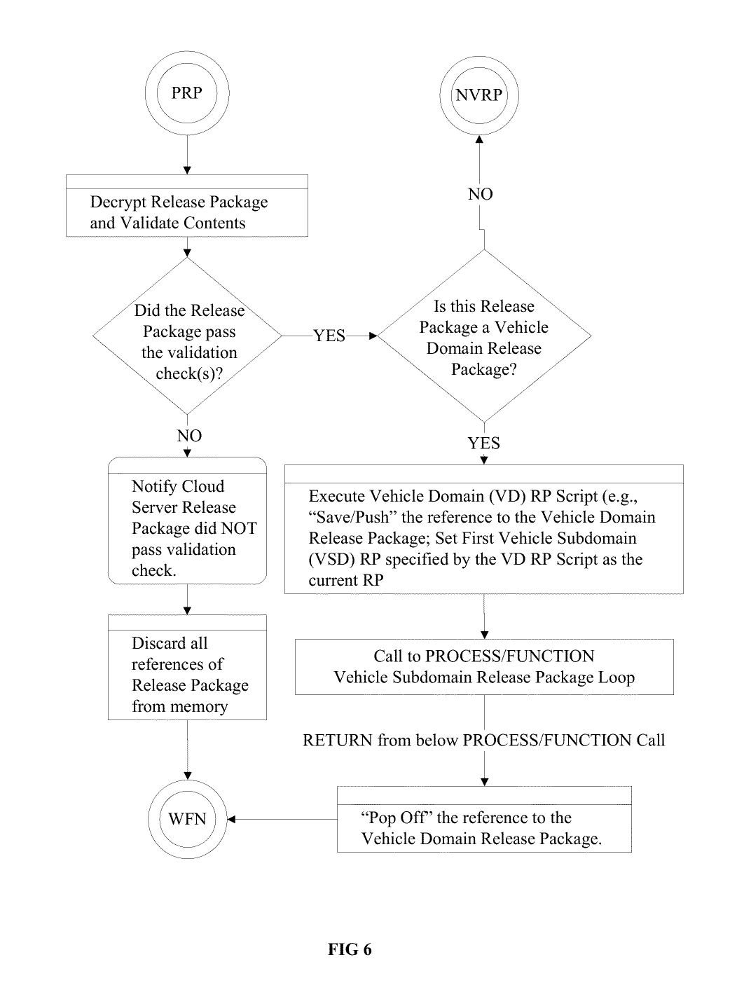

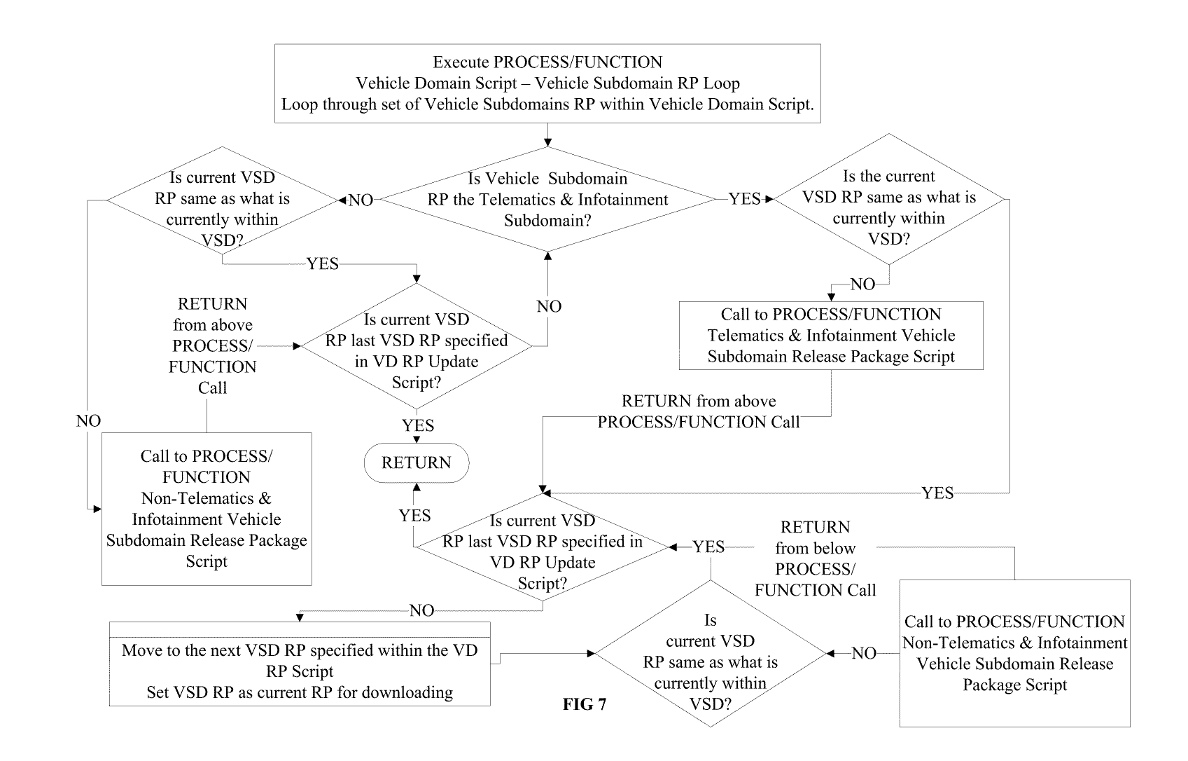

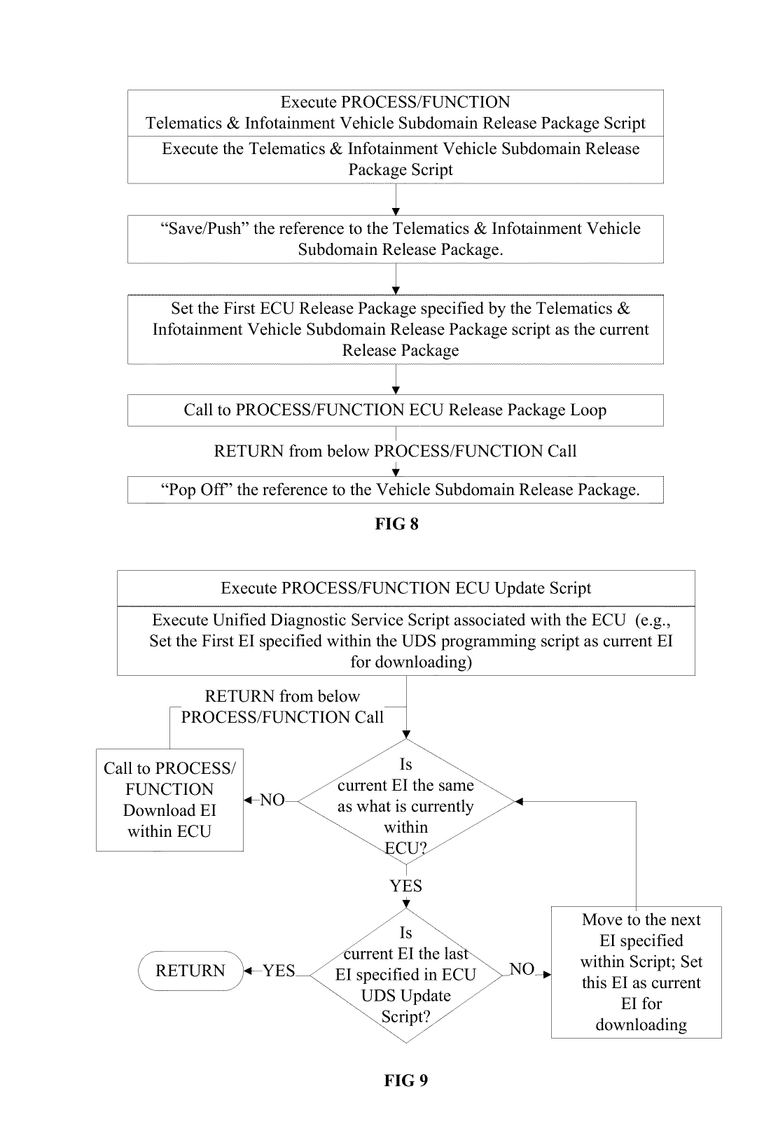

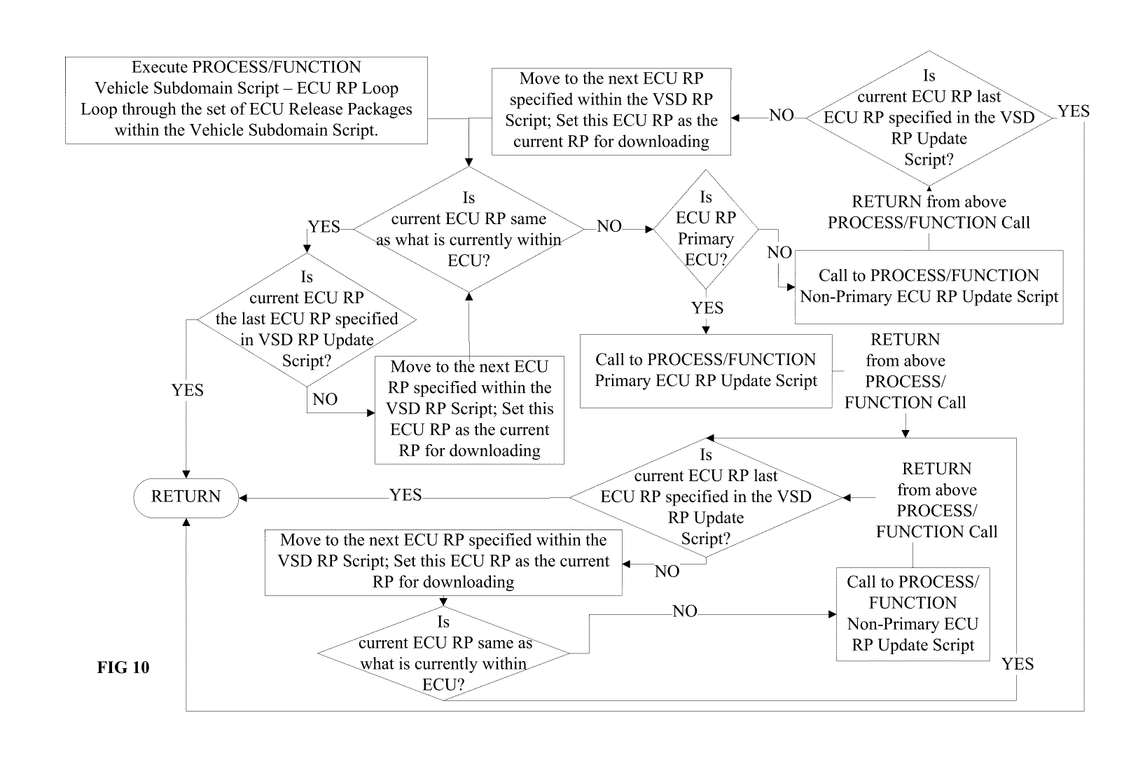

FIG. 5 depicts a vehicle server download process flow from cloud server into head unit. FIG. 6 depicts a vehicle domain (VD) release package (RP) update process. One of the primary functions of VD RP Script is to specify the order that the vehicle subdomain (VSD) RPs are executed. FIG. 7 depicts a vehicle domain (VD)—vehicle subdomain (VSD) release package (RP) loop process. FIG. 8 depicts a telematics & infotainment vehicle subdomain release package update process. One of the primary functions of the Vehicle Subdomain Release Package script is to specify the order that the ECU Release Packages are executed. FIG. 9 depicts a Telematics & Infotainment ECU Release Package update process. The primary function of the UDS script used here is to update the ECU hardware with the core/fundamental Electronic Images required for the ECU to run with full functionality. FIG. 10 depicts a Vehicle Subdomain—ECU Release Package loop process. Additional systems are described below.

The system depicted in FIG. 11 may take various configurations within the scope and spirit of the invention. For example, the disclosed system shown in FIG. 1 may be configured to include one or more VCCSs, a network cloud consisting of any sort of network/communication pathway, a vehicle gateway interface (VGI) at the vehicle or in communication with the vehicle (e.g., a transceiver for receiving and transmitting data, including an on-board WiFi transceiver, an on-board satellite transceiver, an on-board radio frequency/cellular transceiver, an external personal computer (e.g., smart phone), etc.). As shown, the VGI may directly or indirectly communicate with one or more configuration servers at the vehicle, including an engine bay configuration server, a chassis configuration server, an infotainment configuration server, and a telematics configuration server. Each configuration server, which may be a standalone device or embedded within an existing module, may communicate directly or indirectly with one or more ECUs. One of skill will appreciate that some components may be omitted for certain embodiments. For example, the configuration servers may be omitted, and the transceivers may connect directly to the ECUs.

The VCCS may be configured to maintain a database (not shown) of EIs associated with different vehicles (e.g., according to according to make, model, and year) and different ECUs. Accordingly, the OEMs may provide the VCCS. Alternatively, a third party may maintain the VCCS. The database or portions of it may be alternatively or also hosted at a location apart from the VCCS, including a personal computer of a vehicle owner, an authorized distributor of EIs, or another entity. EIs may be downloaded by these other entities using the network cloud of FIG. 1.

A database at or connected to the VCCS may store EIs in the form of RPs across various vehicles manufactured by particular OEMs and the ECUs associated with the EIs. The RP may be defined to be the complete collection of EIs according to a specified delineation. The databases may also store vehicle history and other information about the vehicle.

The VCCS may also monitor information received from the vehicle in order to determine if a modification to the EI or a new EI may be needed, and then may transmit the modification or new EI to the vehicle. Thus, corrupt, malfunctioning, or impaired performance of the ECU or other component may be detected in real time, and a fix may be sent to the vehicle.

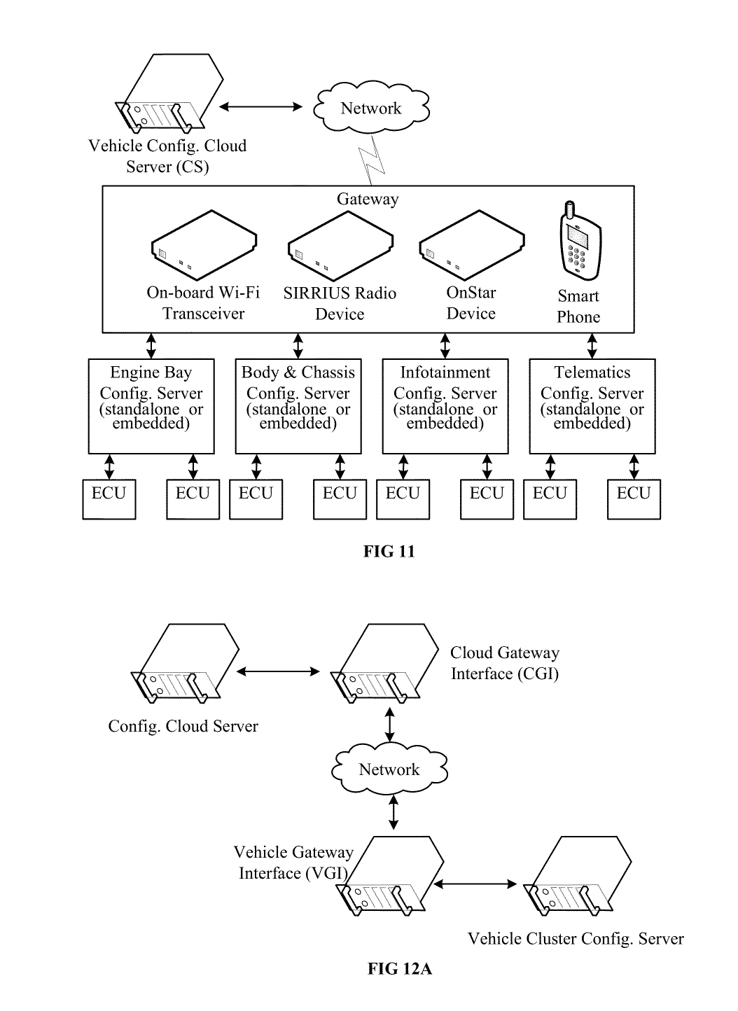

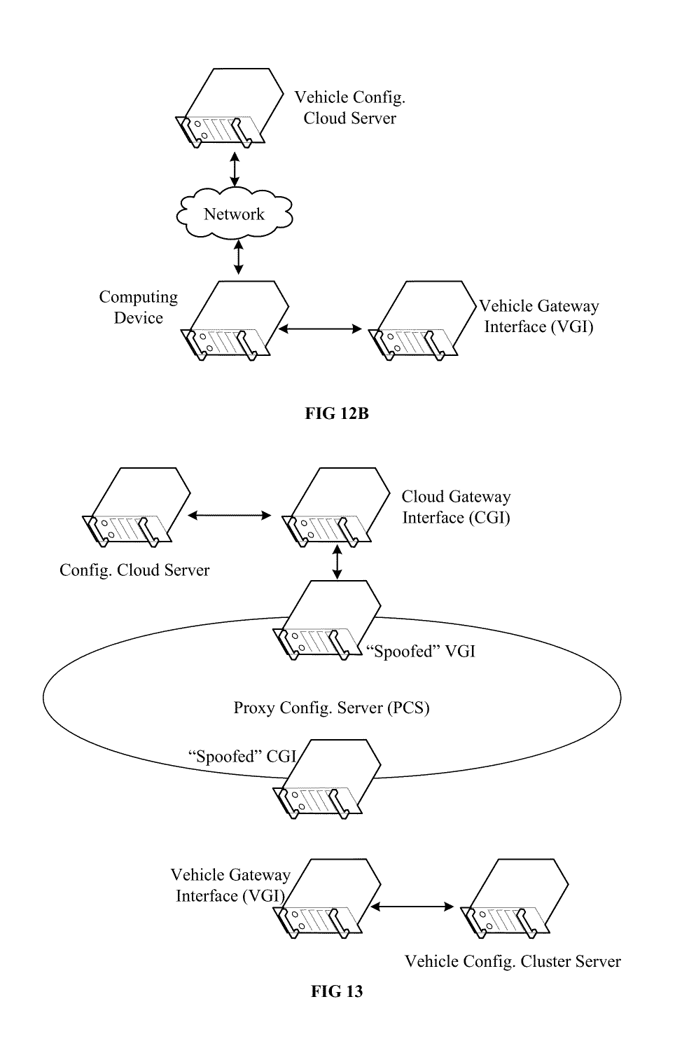

Attention may be turned to FIG. 12a, which illustrates the relationship between the VCCS and the VGI. As shown, the VCCS communicates to the vehicle via any one of a number of mediums and passes through the VGI. The VGI may and probably will vary from OEM to OEM, and may be customized accordingly. However, it must functionally interface on both data interfaces with the VCCS operates and the LVC-CS, respectively.

A Cloud Gateway Interface (CGI) may manage the data communication links between the VCCS and the LVC-CS via the VGI. ECU. The CGI may be an abstraction layer for a VCCS. As an abstraction layer, it may be highly dependent upon the operating system utilities and features available to it on the physical layer of its interface. Its primary responsibility may be to manage the physical connection between itself and its counterpart VGI on the other end of the pipe. By setting up and managing the physical connection between the two ends, it thus enables a data path for the VCCS.

FIG. 12b illustrates a logical connection between the cloud and the vehicle. As shown a Cloud Connection Manager (CCM) manages the logical connection between itself and counterpart Connection Manager on the other end of the pipe (e.g., the Vehicle Cluster Connection Manager). By setting up and managing the physical connection between the two ends, it thus enables a communication path for any component that sits on top of it (e.g., a VCCS Database Manager (VCCS-DM) (not shown)). As part of its duties for providing the logical connection, the CCM: notifies individual Vehicle Cluster Connection Managers when updates may be available; establishes connections with the individual Vehicle Cluster Connection Manager within individual vehicles upon request (e.g., via a two-way communication data link); establishes broadcast connections when necessary and/or desired (e.g., notifications to all owners of a particular make, model, and year that a specific update may be available); and monitors the progress of the update, including the number of bytes for tracking the extent of any one download.

A VCCS Database Manager (VCCS-DM) (not shown) may manage any or all of the databases, including: the Electronic Image database; the ECU Release Package database; the Vehicle Cluster Release Package database; and/or the Vehicle Release Package database. These databases may be built and maintained using SQLite, as mandated by GENIVI. (Note—more information on the SQLite software library may be found at, http://www.sqlite.org). The primary duties of VCCS-DM may include maintaining and updating any/all of the databases, and notifying the CCM whenever new updates may be available.

A VCCS Web Interface (not shown) may provide an HTML interface to the databases (e.g., at an OEM data center). The Web Interface may provide a manual method for updating and maintaining individual databases (e.g., within a Linux Server). The primary duties of this interface may include: providing mechanism for adding new objects to each database; providing mechanism for updating existing objects within each database; notifying the CCM when changes have been to the databases with the expectation being that the CCM will in turn notify individual vehicles; and providing user with ability to monitor progress of database updates and individual vehicle update status.

Attention may be now turned to FIG. 13, which depicts a Vehicle Configuration Proxy Server (VCPS) that acts as a “proxy” to the VCCS in lieu of the VGI, and conversely acts as a “proxy” to the VGI in lieu of the VCCS. Use of a VCPS permits indirect downloads of EIs where transmission of the EI takes an intermediary path to the VCPS and then eventually to the vehicle. This scheme may be designed such that the VCCS has no knowledge as to whether it may be communicating to the actual vehicle or in this case, a proxy for the vehicle. Thus, the VCCS may remain unchanged in its implementation to either the VCPS or the LVC-CS (via the VGI). This means that the interface between the VCPS and the VCCS may behave in the same manner as the interface between the VGI and the VCCS, and that the interface between the VCPS and the VGI may behave in the same manner as the interface between the VGI and the VCCS.

The VCPS must essentially behave the same way as the VCCS apart from spoofing different interfaces as described above. One caveat, however, may be that unlike the VCCS, which may have information on a great number of makes and models for various vehicles, the VCPS may be limited to only the information on one or more specific vehicles that may be associated with the VCPS (e.g., vehicles whose make, model, year, and VIN have been entered into its database). For instance, where the VCPS may be a personal computer of a vehicle owner, that VCPS may only have information associate with that vehicle.

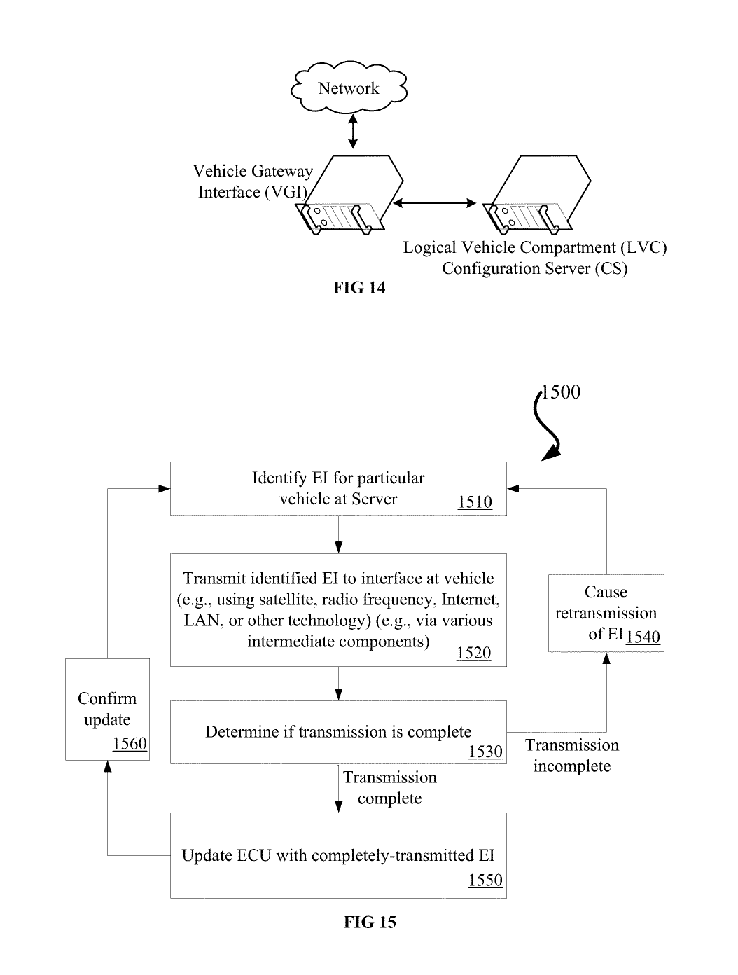

Attention may be now drawn to FIG. 14, which depicts a VGI that may be located within a vehicle and may be that vehicle's portal to the network cloud. The VGI may have various interfaces, including an interface for the network cloud and the ECUs for each individual LVC and the corresponding configuration server. In many cases, the VGI resides in one of the primary ECUs (e.g., in either the primary ECU for Telematics or Infotainment), and therefore resides within the same physical hardware as an LVC-CS. One of skill in the art will appreciate variations to this setup.

The LVC-CS may be the configuration server to all of the ECUs within its domain. This software object usually resides within a master ECU. The LVC-CS may maintain the client to the VCCS as well as the Configuration Server for the LVC for which it may be responsible. The LVC-CS may further be responsible for managing the RPs of all ECUs within its domain, including itself.

The LVC-CS may act as a client to the external configuration server from which it obtains its updates, and may be unaware as to which Configuration Server it may be actually communicating to and may be not aware of whether or not it may be communicating directly to the VCCS, a VPCS in a Wi-Fi network or other communication pathway. It may be completely ambivalent as to where the RP may be obtained, and may be only concerned with whether or not the RP and its contents may be valid.

The LVC-CS may optionally maintain a complete history of updates for the ECUs and their EIs within its domain, at least one full copy of the latest RP for each ECU within its domain, two full copies of the most recent two RPs for itself in the event of either a catastrophic corruption of its most recent RP or in the event of a power loss in the middle of a flash update, and a scratchpad large enough to hold the largest RP within its domain. For example, the scratchpad area may be used for the aggregation of a release package over a period of interrupted downloads. In some cases, only one incomplete RP may be allowed at a given point in time for aggregation. Thus, in order to initiate the update of another RP, the LVC-CS must first abandon the update of any current RP download. The LVC-CS may also provide a frontend engine implementing AUTOSAR UDS ECU programming protocol. This frontend engine may establish a link with the ECU to be updated and subsequently communicating with it, executing the update instructions for the particular EI and or RP.

Attention may be now drawn to FIG. 15, which illustrates a process flow diagram detailing a process 1500 for transmitting an electronic image (EI) to a vehicle in accordance with at least one embodiment of the invention.

At stage 1510, an EI for a particular vehicle may be identified at a server, and at stage 1520, the server causes the transmission of the EI to the vehicle. The transmission of the EI may occur over one or more various communication pathways, including satellite, radio frequency, Internet, local area network or other technologies. Moreover, the EI may transmit through various components before reaching the vehicle. At stage 1530, the vehicle determines if the full EI was received. If the transmission was incomplete, the vehicle causes the retransmission of the entire EI or the remaining portion of the EI at stage 1540. If the transmission was complete, the vehicle updates equipment on the vehicle with the EI at stage 1550. Finally, a confirmation of the update may be sent to the server at stage 1560.

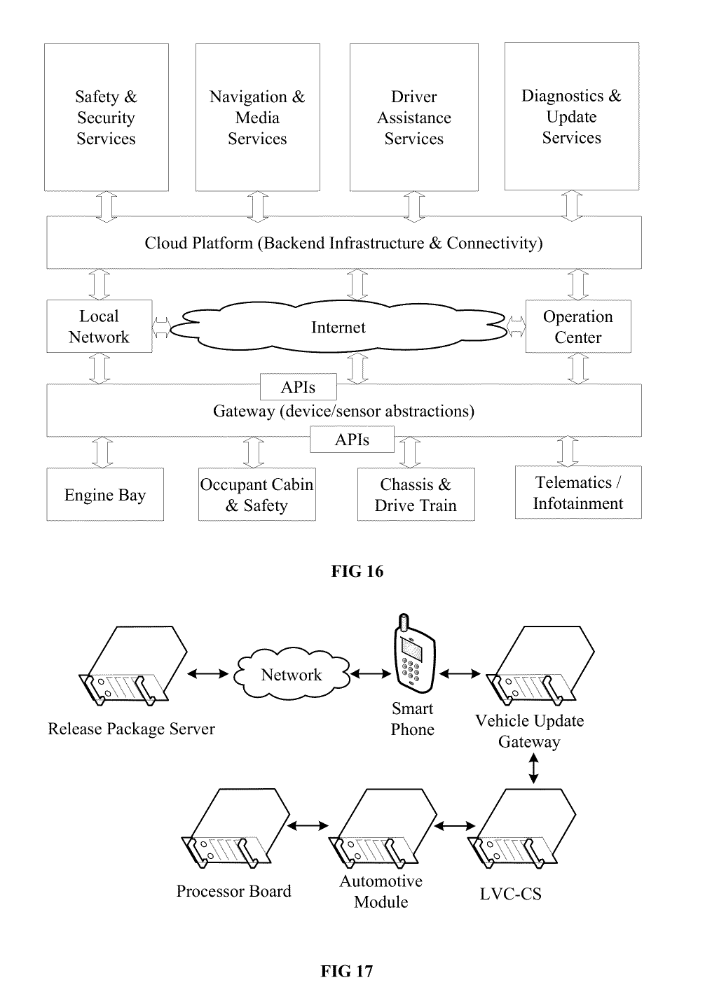

FIG. 16 illustrates a block diagram depicting system architecture in accordance with at least one embodiment of the invention. The Safety & Security Services may include collision notification, emergency call, roadside assistance, vehicle location, alarm notification, eCall and DSRC, among others. The Navigation & Media Services may include Internet apps (e.g., Yelp, Facebook, Google, and others), music and information services, points of interest, route assistance, parking assistance, location-based traffic, and location-based weather, among others. The Driver Assistance Services may include remote door lock/unlock, dealer/OEM connection, tolls & payments, and car information (e.g., fuel, oil pressure, tire pressure, and others), among others. The Diagnostics & Update Services may include remote OBD, FOTA, apps download, and software updates, among others.

FIG. 17 illustrates a block diagram depicting a system for transmission of an electronic image (EI) to a vehicle using a smart phone in accordance with at least one embodiment of the invention. The Vehicle Update Gateway and the LVC-CS may be the same, particularly if the LVC-CS is for the Infotainment portion of the vehicle.

As noted herein, the VCCS ma maintain or connect to a database of ECU EIs. (Note—“image” or “images” may be used herein to refer to “EI” or “EIs”, respectively). The images may be grouped into three different groups.

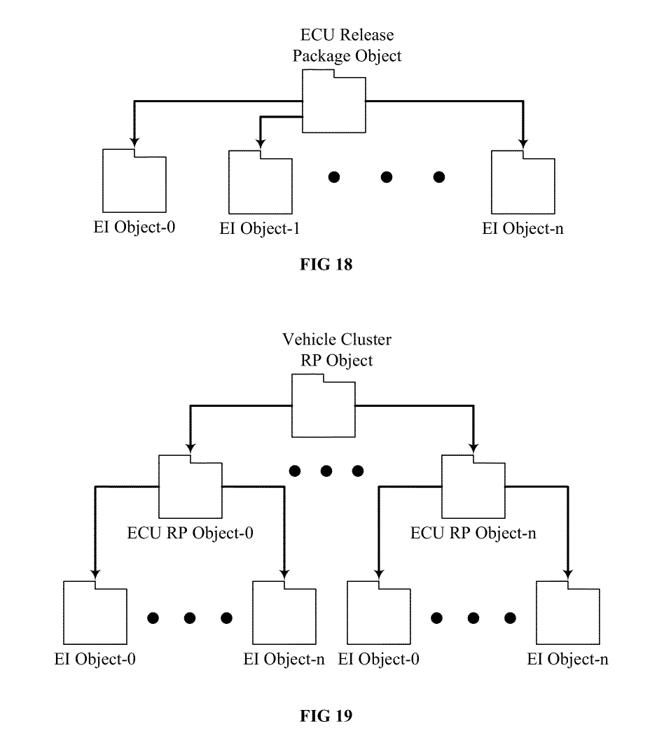

The smallest group may be the set of EI objects found within a single ECU. An ECU usually has at least three (3) or four (4) images, with the minimalist list usually being: Boot-loader; Primary Application; Configuration Data; and One or more programmable logic device files. Additional images within a single ECU may be usually of some combination of the above listed four types of images and possibly for “other” processors within the same ECU (e.g., LCDs, Communication Peripherals, Compression or Encryption Processing Engines, etc.). For reference, FIG. 18 depicts an ECU Release Package Object containing up to n EI objects. In accordance with one aspect of the invention, objects in an EI database may contain the actual downloadable image. However, the ECU Release Package may contain instructions kept in UDS Script format precisely describing how each EI will be downloaded.

The next group may be the Vehicle Cluster Release Package (VC-RP), which may consist of all ECU Release Package Objects within a single Vehicle Cluster, where each ECU Release Package in turn identifies a specific set of EI Database record objects. For reference, FIG. 19 depicts a VC-RP. Each Vehicle Cluster Release Package object may identify ECU Release Package objects within the Vehicle Cluster on a per ECU basis. One or more modules (e.g., ECUs) within a single vehicle cluster may have the same image as “other” ECUs (where the shared image may be both within the same Vehicle Cluster as well as other vehicle clusters). However, care should be taken in how EI database objects may be shared between ECU Release Packages since two different ECUs may call for different versions of the same EI. In this case, two different EI database objects will necessarily be created and maintained.

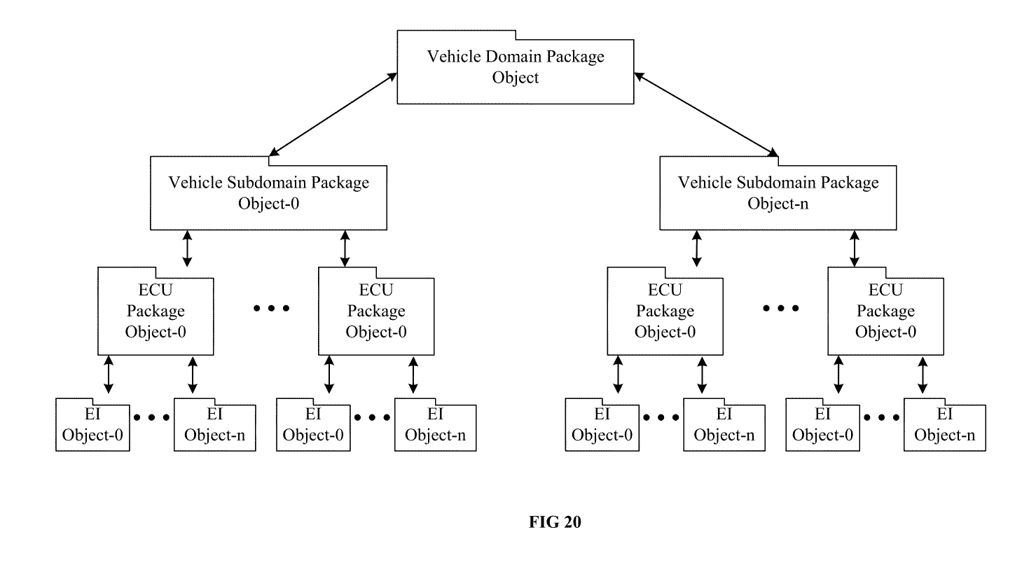

The last group may be the Vehicle Release Package (V-RP) and may consist of the individual Vehicle Cluster Release Packages; each of which may identify a specific set of ECU Release Packages, which in turn identifies a specific set of EI database record objects. For reference, FIG. 20 depicts a V-RP. In accordance with some aspects, there may be only three different categories of Vehicle Clusters: Telematics & Infotainment; Body & Chassis; Engine Bay. However, additional categories are contemplated.

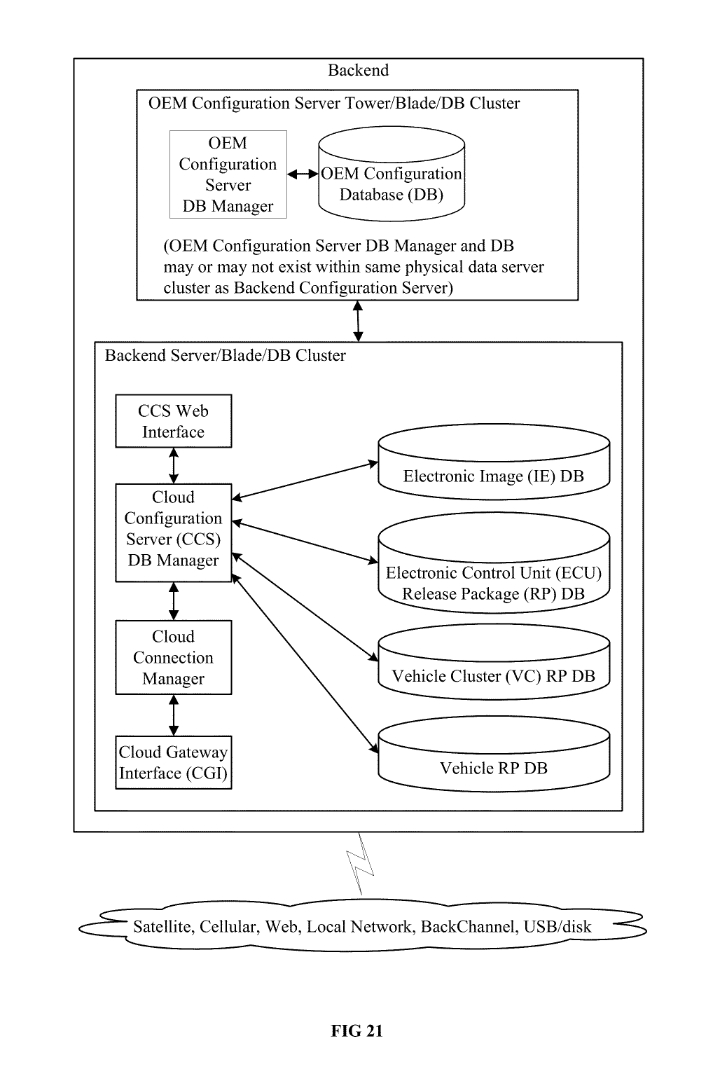

There may be a variety of options for implementing aspects of the systems and methods for remote updating of EIs at vehicles. FIG. 21, for example, depicts one implementation using an OEM cloud server and database architecture. As shown, certain of the inventive features of the invention may be reliably used as a software and hardware solution for OEMs to reduce interoperability issues across systems.

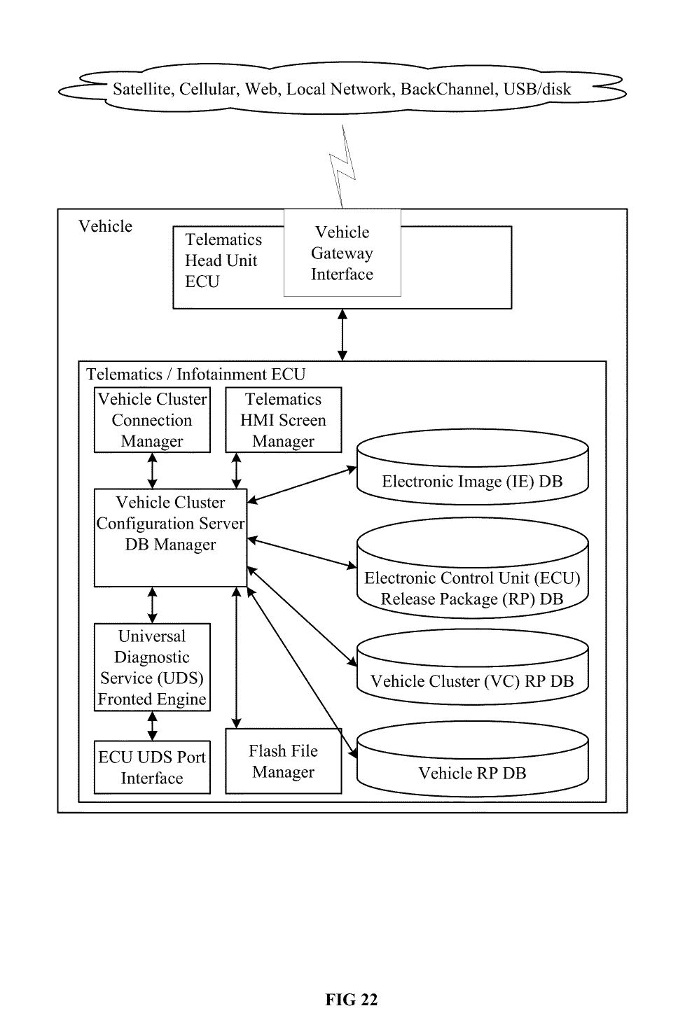

Attention is now turned to FIG. 22, which depicts several components within the vehicle, including: Vehicle Gateway Interface (VGI); Vehicle Cluster Connection Manager (VCCM); Vehicle Cluster Configuration Server (VC-CS) Database Manager; Telematics HMI Screen Manager; Flash File Manager; Universal Diagnostic Service (UDS) Frontend Engine; and UDS Port Interface Connection Manager (PICM).

The Vehicle Gateway Interface (VGI) may manage the data communication links between the Vehicle Cluster ECU and the Cloud Server. The VGI may be an abstraction layer for the Vehicle Cluster Connection Manager. As an abstraction layer, it may be highly dependent upon the operating system utilities and features available to it on the physical layer side of its interface. Specifically, it may need to interface to the GENIVI compliant, “Connection Manager”, as referenced within the GENIVI specification. Source code for the ConnMan implementation may be found at, http://connman.net/. The primary responsibility of the VGI may be to provide a data path between the Vehicle Cluster Connection Manager and one of the data ports for which it may be responsible via the aforementioned ConnMan GENIVI specified mechanism. The VGI may support the following connections: Wi-Fi; USB; Ethernet (for diagnostic connections); 3G/4G cellular connections; OnStar cellular connection; and be capable of monitoring and intercepting a SiriusXM satellite broadcast.

The Vehicle Cluster Connection Manager (VCCM) may manage the data path between the VCCS and the VGI. Primary duties of the VCCM may include: receiving notifications from the Cloud Connection Manager (CCM) when updates may be available; establishing connections with the Cloud Connection Manager (CCM) (assumes two-way communication on data-link, which may be the overwhelming nominal case); establishing receive end of broadcast connections when necessary and/or desired (e.g., notification to all owners of a particular make, model, and year that a specific update may be available); aggregating in a set aside RAM Disk and temporarily maintaining in flash storage when necessary; monitoring the progress of the update, including the number of bytes and report back to the Cloud Connection Manager the number of bytes aggregated in the event the link fails; and notifying Vehicle Cluster Configuration Server upon completion and subsequent verification and decrypting of update download.

The Vehicle Cluster Configuration Server Database Manager may manage any/all of the databases. The databases may be built and maintained using SQLite, as mandated by GENIVI. more information on the SQLite software library may be found at, http://www.sqlite.org. The primary duties of the Vehicle Cluster Configuration Server Database Manager may include: maintaining and updating as needed the EI database, ECU-RP database, VC-RP database, and V-RP database; receiving and acknowledging notification from the OEM Cloud Server indirectly through VCCM whenever new updates may be available; receiving aggregated update once complete; distributing EIs from completed aggregated update; and notifying the VCCM that all updates have been completed and/or any issues preventing the updates.

The Telematics HMI Screen Manager may provide an HTML 5.0 GENIVI compliant interface to the databases within the Master ECU. Its primary purpose may be purely to report historical information, including status and error reporting. the Telematics HMI Screen interface may utilize the aforementioned GENIVI compliant “Connection Manager.”

The Flash File may manage the images which the boot-loader loads upon system reset. Additionally, the boot-loader code may be modified in accordance with the update methodology of the Update Framework. Specifically, this implies that there may be always two complete sets of images within the flash from which the boot-loader may load. The designated image set may be the image set designated as primary and indicated as such by a flag that can be read at system reset by the boot-loader. Typically, the location of the primary flag will be within an EEPROM or other persistent storage technology. The absolute offsets of the two images may be known at system compilation time so that only the selection of which image may be primary needs to be a volatile value saved in persistent storage. The Flash File Manager may designate the latest image set loaded as primary unless directed otherwise by a command from the VCCS or other source.

### Configuration Management Objects and Other Aspects in Certain Embodiments

Configuration management objects may be those entities within, for example, the system of FIG. 1 or FIG. 2 that may be exchanged between the two ends of the system. The configuration management objects describe the transferred data and the organization of that transferred data. Configuration management objects may be divided into four categories: (1) DATA (e.g., EIs); (2) SCRIPTS (e.g., Programming Scripts); (3) LOGICAL GROUPING-I (e.g., VCCS Database Objects); (4) LOGICAL GROUPING-II (e.g., VCPS Database Objects).

The first category comprises the set of objects that may be being managed. The second category of objects control how the data objects identified in the first set will be treated. The third category of objects specify how to group objects identified in the first two categories of objects. Finally, the fourth category of objects may be the resultant aggregation of objects identified from the first two categories as organizationally specified by objects from the third category.

### First Category of Objects (e.g., EIs) and Other Aspects in Certain Embodiments

ECUs included embedded devices designed explicitly for the automotive market and as with any embedded device, EIs (EIs) usually fall into one of four categories, including a ‘Firmware Image’ category (e.g., defined to be a complete standalone executable image that executes on specific processor within the ECU), a ‘Software Image’ category (e.g., defined to be an executable that integrates into an existing firmware image after the firmware image may be up and running), a ‘Data Image’ category (e.g., defined to be any set of data, configuration or otherwise, that may be used by some component within the ECU), and a ‘Programmable Logic Device Image’ category—(e.g., defined to be an executable image targeted for a specific type of FPGA, CPLD, XPLD, etc.)

Thus, any given EI can be thought of as the “payload” for remote update process. It, along with other related EIs may be the entities being delivered from the designated VCCS to a specific ECU of a vehicle. EIs may be grouped together at the most basic level for a specific release of an ECU. This means that whatever group of EIs that was used, tested, and verified to work together by the ECU manufacturer may be organized into a single entity called an ECU RP. In general, RPs may be organized according to physical and logical boundaries. Specified delineations for an RP, listed in increasing scope and complexity include: ECU RP (as mentioned above, this may be the most basic grouping of an RP); LVC RP; and Vehicle RP. As part of the RP process, the ECU manufacturer may certify that all of the EIs within the RP have gone through validation & verification (V&V) testing to ensure they work together and operate as both designed and expected. Validation requirements may be supplied by the OEM, and may comply with governmental regulations. The Verification requirements may be supplied by the ECU manufacturer (e.g., OEM or Tier 1).

### Second Category of Objects (e.g., Programming Scripts) and Other Aspects in Certain Embodiments

The programming scripts maintained within the Vehicle Configuration Databases fall into one of four categories: EI Programming Scripts (e.g., AUTOSAR Compliant diagnostic ECU image update scripts, which may be paired with each EI and may be used to remotely control the target ECU for downloading); ECU Programming Scripts (e.g., Programming Script specifying the relative order in which: the EI Programming Scripts may be run; and other information that may be required to complete programming of the ECU and may be not or cannot be contained within any of the EI Programming Scripts); LVC Programming Scripts (e.g., Programming Script specifying the relative order in which the ECUs within an LVC may be programmed); and Vehicle Programming Scripts (e.g., Programming Script specifying the relative order in which the LVCs within a Vehicle may be programmed).

### Data Sources and Other Aspects in Certain Embodiments

In accordance with certain embodiments, there may be four different categories of databases maintained within the systems described herein that have notable distinctions:

The first database category may consist of the data objects that the remaining databases may be all built upon and may be only maintained on the VCCS. Where the database must maintain an enormous amount of data, the database may be designed to minimize redundancies, and hence, the amount of storage required to maintain necessary the information. In this scenario, only the skeleton infrastructure of all of the various types of RPs may be maintained so that the database does not need to keep two copies of any given single object anywhere within its memory space. Actual RPs may be assembled in real time according to the identifying keys within each RP object.

Each subsequent database may be built upon objects from the immediate prior enumerated database (e.g., the ECU objects contain the EI objects). The VCCS databases, for example, may be relational databases with multiple keys, whose objects may be maintained in any manner desired. The VCPS may have only one database category whose objects may be strictly ordered in a linearly sequential manner as a means of simplifying the processing of them on their intended targets.

In order to adequately maintain an EI, additional information may be maintained at the database(s) beyond the EI. For example, primary fields found in any EI database object may include: [KEY] ECU Type Field (implies general category such as the Powertrain Control Module); [KEY] ECU Manufacturer Field; [KEY] ECU Model Field; [KEY] ECU Subcomponent Type Field (e.g., FEC, FPGA, CPLD, LCD, etc.); [KEY] ECU Subcomponent ID (8-bit numeric identifier); [KEY] ECU EI Release Version Number Field; [Data Content] ECI EI Certificate Number (Zero if no certification); [Data Content] EI Programming Script; [Data Content] EI; [Data Content] EI 32-Bit CRC; and [Data Content] EI DB Record 16-Bit CRC. Description of some of these fields may be provided below.

The EI Certificate Number may be a number obtained by a certification body providing confirmation that the EI went through a minimal degree of V&V testing. However, at this level, this could also be “self-certification” and does not necessarily requiring a formal validation from an independent body.

The EI Programming Script may be comprised of Executable AUTOSAR Compliant Unified Diagnostic Service (UDS) Instructions to be run by the LVC-CS ECU on an UDS Engine within the Image's Target ECU. Thus allowing the LVC CS Application performing the remote download and subsequent remote flashing to be designed in such a manner that it may be agnostic and unaware of any details specific to the image or the ECU it may be interfacing to. By including specific instructions for each ECU RP and each ECU EI, the entire interface and the Download Management Software may be both generic and extremely straightforward (e.g., the frontend of a download engine), thus, greatly simplifying the entire process and resulting resident code within whichever device contains the Download Management Software. The EI may be the actual Image itself (i.e. the thing that may be downloaded into the ECU).

The complete and formal aggregation of images found within a single ECU may be said to be within an ECU Release Package. By way of example, the primary fields found in any EI database object may include: [KEY] ECU Type Field (implies general category such as the Powertrain Control Module); [KEY] ECU Manufacturer Field; [KEY] ECU Model Field; [KEY] ECU RP Release Version Number Field; [Data Content] ECU RP Certificate Number (Zero if no certification) (e.g., certification on the ECU level implies cross-reference of all images contained within the specific ECU Release Package); [Data Content] ECU RP Programming Script; [Data Content] Number of ECU EIs; and [Data Content] ECU EI Array (e.g., each sub-record in this array may contain sufficient information to identify the precise EI record in the EI Database). The ECU EI Array may be arranged as follows: ECU Subcomponent Type Field (e.g., FEC, FPGA, CPLD, LCD, etc.); ECU Subcomponent ID (8-bit numeric identifier); ECU EI Release Version Number Field; and ECU EI DB Record Number. A ECU RP DB Record 16-bit CRC, which may only be valid when the ECU-RP Array within this record may be fully expanded (i.e., all of the ECU EI Data Content fields, including the EI image for each ECU EI record have been merged into the ECU-RI array). Certain fields may be described below.

The ECU RP Certificate Number may be a number obtained by a certification body providing confirmation that the EI went through a minimal degree of V&V testing. However, at this level, this could also be “self-certification” and does not necessarily requiring a formal validation from an independent body.

The ECU RP Programming Script may be an executable script specifying the relative order and other related information necessary for updating the ECU in the appropriate sequence. This script may act as a “master” script over the image specific UDS script found within each ECU EI Database Record object.

The Number of EIs may specify the number of Image Release Packages, where, ‘x’ represents the number of images.

When creating an ECU Release Package the ECU EI Database Record Number field may be replaced by the Data Content fields of the ECU EI DB Record, including the entire ECU EI. The only exception to this rule may be if the ECU EI DB record did not change between releases of the ECU Release Package versions, the ECU EI field will be all zeros.

The complete aggregation of ECU Release Packages within a single LVC may be said to be within an LVC RP. The primary fields found in any EI database object may include: [KEY] Vehicle Manufacturer Field (e.g., not necessary for the VCCS database, but may be necessary for the linearly sequenced release package that may be generated for the LVC-CS); [KEY] Vehicle Model Type Field; [KEY] Vehicle Compartment Type Field; [KEY] LVC-RP Release Version Number Field; [Data Content] LVC-RP Certificate Number (Zero if no certification) (e.g., certification on the Logical Vehicle Compartment Level (i.e., Engine Bay, Body & Chassis, Infotainment, and Telematics) implies cross-reference of all images contained within a specific LVC RP); [Data Content] LVC Programming Script; [Data Content] Number of ECU Release Packages; [Data Content] ECU RP Array (e.g., each sub-record in this array contains sufficient information to identify the precise ECU Release Package record in the ECU Release Package Database). The ECU RP Array may be arranged as follows: ECU Type Field (implies general category such as the Powertrain Control Module); ECU Manufacturer Field; ECU Model Field; ECU Release Version Number Field; and ECU RP DB Record Number (e.g., when creating a downloadable LVC Release Package, this field may be replaced by the Data Content fields of the ECU RP DB Record). The ECU RP DB Record 16-bit CRC may only valid when the fields specified in above have been expanded. The LVC RP DB Record 16-bit CRC may only valid when the ECU-RP Array within this record may be fully expanded (i.e., all of the ECU EI data content fields, including the EI image for each ECU EI record have been merged into the ECU-RP array). The ECU RP Programming Script may be an executable script specifying the relative order and other related information necessary for updating the ECUs in the appropriate sequence.

The complete aggregation of LVC RPs within a single vehicle may be defined comprise a Vehicle RP. Descriptive information within a Vehicle RP includes, but may be not limited to, the following information: [KEY] Vehicle Manufacturer Field; [KEY] Vehicle Model Type Field; [KEY] V-RP Release Version Number Field; [Data Content] V-RP Certificate Number (Zero if no certification) (e.g., certification on the Vehicle Level implies cross-reference of ALL images contained within a specific Vehicle Release Package); [Data Content] Vehicle Programming Script; [Data Content] LVC RP Array (e.g., the number of elements within the array may be no more than four; one for each different types of Logical Vehicle Compartments (i.e. Infotainment, Telematics, Engine Bay, Body & Chassis)). The LVC RP Array may include: [Descriptive Data] Vehicle Compartment Type Field; [Descriptive Data] LVC-RP Release Version Number Field; and LVC DB Record Number (e.g., when creating a downloadable Vehicle Release Package This field may be replaced by the Data Content fields of the LVC RP DB Record). The Vehicle RP DB Record 16-bit CRC may only valid when the LVC-RP Array within this record may be fully expanded (i.e., all of the ECU RP arrays for each LVC have been merged into the LVC-RP array). Some fields may be described below.

The Vehicle RP Programming Script may include an executable script specifying the relative order and other related information necessary for updating the LVCs in the appropriate sequence. The Logical Vehicle Compartment Release Package Array may include an array for the Number of LVCs (i.e. four types—Engine Bay, Body & Chassis, Telematics, Infotainment) containing the relative offset from the beginning of the package of each ECU RP within the LVC RP.

Objects within a VCPS Database may be fully expanded RPs, regardless of whether or not the RPs may be abbreviated release packages or complete RPs. A fully expanded Complete RP may have all Data Content fields filled in with non-zero values; whereas a fully expanded Abbreviated RP may have zero values for Data Content fields of RPs that did not change between release versions of the encompassing object.

One of skill in the art will readily understand various features of the aspects described herein. For instance, various aspects provide for an end-to-end solution; a full configuration management of ECU releases; management of applications at both ends (e.g., VCCS and LVC-CS). One or more aspects provide for aggregation of EIs (EIs) in the form of Release Packages (RPs) at logically encompassing levels (e.g., ECU; LVC (i.e. Engine Bay, Body & Chassis, Telematics, and Infotainment); vehicle). One or more aspects provide for simplicity in that only a one-way data stream may be required for standard updates. One or more aspects provide for a complete and flexible system with an individual vehicle database maintained within the vehicle's LVC-CS ECU, or optionally maintained on OEM VCCS and/or a user-specified Vehicle Configuration Proxy Server. One or more aspects provide for further flexibility and simplicity in that a universal update mechanism may be used via AUTOSAR UDS for remote control and update of subordinate ECUs.

One or more aspects provide for multiple certification levels according to an aggregation level (i.e. ECU EI, ECU, LVC, and Vehicle level certifications). One or more aspects provide for efficiency where, regardless of aggregation level, release packages may be limited to only those images that actually changed. Thus, release packages with identical image releases across RP versions do not include identical images across subsequent release packages unless a complete RP may be explicitly requested. Therefore, download times may be reduced as compared to traditional update methodologies.

One or more aspects provide for additional safety because multiple levels of CRC checks ensure the RP and enclosed images may be downloaded intact, without any loss or corruption of data. One or more aspects provide for security by using end-to-end encrypted RPs (e.g., encrypted via AES Private Key encryption). Private Key may be known to all vehicles on a communication link, but may be updated on a frequent, periodic basis.

One or more aspects provide for both flexibility and reliability with an ability to regress or progress across multiple revisions (i.e., the inventive system and methods may be not restricted to one revision regression or progression). The only restriction to the number of revisions an update may go forward or backward may be directly dependent on whether or not data structure conversions may be required as part of the update. As most of the time data structure conversions may be only performed between two consecutive revisions and not across multiple revisions.

One or more aspects provide for a reliable Intelligent Download Aggregation Methodology where all downloads come in the form of Release Packages and where the Release Packages will aggregate over a series of download stops and starts. In this way, the LVC-CS remembers where it left off within the download process. One or more aspects provide for a reliable ability to recover corrupted images within a vehicle. Every master ECU may contain two complete release packages for itself and a complete copy of the most recent revision of the release package for each ECU within its domain. One or more aspects provide for flexibility where the system operates over a variety of physical data link combinations (e.g., SIRIUSXM Satellite, OnStar, Cellular 3G/4G, Wi-Fi, other networks, as well as derivations of each one). One or more aspects provide for flexibility where the various system components may be agnostic to the logical data transmission methodologies (e.g., HTTP 1.1, FTP, Red Bend vDirect Mobile Framework). One or more aspects provide for flexibility where there may be optional enforcement of certification levels above that of the ECU Release Package.

### Use Cases in Certain Embodiments

Various scenarios (i.e., use cases) may be contemplated. Accordingly, the aspects described herein may be implemented in relation to the following use cases: Vehicle configuration update utilizes virtual connection between VCCS and LVC-CS; Vehicle Configuration Proxy Server connects to VCCS as a “proxy” for the LVC-CS to the VCCS; Vehicle Configuration Proxy Server connects to the LVC Server as a “proxy” for the VCCS; Vehicle Configuration [Cloud or Proxy] Server notifies vehicle that updates may be ready to be downloaded, and notification mechanism may or may not be dependent upon or related to download technology; VCCS connects to Vehicle Gateway Interface via SIRIUSXM Satellite Link; VCCS connects to Vehicle Gateway Interface via Cellular network on Smart Phone connected to VGI either through Wi-Fi, Bluetooth, USB cable or other means; Smart Phone Connection acts as pass-through data bridge for cellular connection; Smart Phone Connection acts as data collection point for cellular connection. Subsequently downloads at user discretion to VGI either through Wi-Fi or USB cable; VCCS connects to VGI via OnStar proprietary cellular network; Vehicle Configuration Proxy Server connects to VGI via OEM specified Wi-Fi “Hot Spot” (e.g., at dealer location) and OEM specified “Hot Spot” could be for those whose home network may be not in range of their vehicle (e.g., high-rise occupants whose parking garage may be out-of-range); VCPS connects to VGI via vehicle owner specified Wi-Fi “Hot Spot” (e.g., vehicle owner's home); Vehicle Configuration Proxy Server connects to vehicle owner USB Thumb-drive. USB Thumb-drive may be then inserted into VGI USB port; Vehicle Configuration [Cloud or Proxy] Server link takes multiple iterations to complete vehicle configuration update without resending any previously sent data (i.e. data may be aggregated and stored and LVC remembers what it last received); LVC-CS updates itself with most recent download; LVC-CS regress back one version (i.e. to secondary copy) after either detecting user direction to do so or detecting current version corrupted (NOTE: secondary copy may be re-designated as primary copy; prior primary copy may be re-designated as secondary copy); LVC-CS may be interrupted by power loss during update (NOTE: updates always overwrite the secondary copy so that the primary copy may be intact until the updated copy in the secondary copy's area may be verified; at which point the primary copy becomes the secondary copy); LVC-CS must have ability to regress two (2) or more versions back (NOTE: LVC-CS must “request” specific Release Package from VCCS); LVC-CS updates subordinate ECU with complete ECU Release Package; LVC-CS updates subordinate ECU with ECU Abbreviated Release Package.

Systems and methods in accordance with certain aspects may be an extended Configuration Management & Delivery Ecosystem that provides a complete end-to-end solution from an Internet Cloud Server down to a Vehicle Server that maintains and then distributes Electronic Image (EI) updates of Electronic Control Units (ECUs) within automotive vehicles, but may also be applied for other sets of EIs and applications, not just automotive; particularly wherever there are a disparate, but related group of different hardware (with respect to hardware manufactures) centered around a core application that may meet some common communication and operational standard in order for them to all integrate into a larger, but common, eco-system.

One ecosystem organizes, manages, and transfers: Electronic Images (EIs) residing within the Electronic Control Units (ECUs) of automotive vehicles. ECU sets of EIs, whose elements are specified herein and are grouped as a complete set of EIs specific to a particular ECU. Vehicle Subdomain sets of ECU EI sets, whose elements are specified herein and are grouped as a complete set of ECUs within a specific Vehicle Subdomain. Vehicle Domain sets of Vehicle Subdomain sets, whose elements are specified herein and are grouped as a complete set of Vehicle Subdomains within a specific Vehicle Domain. Currently, vehicle control systems are divided into three vehicle subdomains: a) Telematics & Infotainment; b) Body & Chassis; and c) Engine Bay. These three vehicle subdomains comprise a single, complete Vehicle Domain. EIs, EI ECU sets, EI Vehicle Subdomain sets, and EI Vehicle Domain sets; according to some cross section of the aforementioned for organizing EIs for specific Aftermarket Telematics & Infotainment Head Unit ECUs.

One ecosystem maintains: EIs according to an organizational structure that may be capable of being Vehicle OEM centric for organizing all of the ECUs and their EIs of a particular Vehicle OEM across all applicable makes, models, and model years. EIs according to an organizational structure that may be capable of being Aftermarket Manufacturer centric with the central organizing entity being the Aftermarket Manufacturer's Telematics & Infotainment Head Unit. EIs within the vehicle without any foreknowledge of the other ECUs nor their EIs; and using only the predefined organizational structure as the primary means for delineating and organizing the EIs within the overall Vehicle ECU EI database. E.g., One and only one unique copy of EIs regardless of diversity of the number of ECUs it might be found in. The BIOS may be an example of an Electronic Image which may appear in multiple ECUs, but need only one copy maintained across the entire EI database.

One ecosystem requires an accepted EI structure (as referenced herein that may be an Arynga devised scheme and includes specific information required to identify Electronic Images (EIs) (these are the “core” elements being managed within the system. All other structures are either supporting elements of EIs or they have additional hierarchical information in organizing sets of EIs. These additional elements are as follows: ECU sets of EIs; Vehicle Subdomain sets; Vehicle Domain sets; EI Programming Scripts, where these scripts are always some form of Uniform Diagnostic Service (UDS) script, with top two UDS scripts supported are from: VectorCAN; and AutoSAR. There may be a one-to-one relationship between a specific EI and a specific ECU with regard to an EI scripts. Meaning, each UDS script may be unique to that ECU for that particular EI. ECU Programming Scripts for specific ECU sets. This may be a TBD scripting language whose primary, but not sole purpose, may be to specify the order for which the EIs get programmed within a particular ECU. That is, it may be that the script specifies the order the UDS scripts specified herein are executed. Vehicle Subdomain Programming Scripts for specific Vehicle Subdomain sets. This may be a TBD scripting language, whose primary, but not sole purpose, may be to specify the order for which ECUs are programmed within a particular Vehicle Subdomain. That is, it may be this script that specifies the order the ECU programming scripts specified herein are executed. Vehicle Domain Programming Scripts for specific Vehicle Domain sets. This may be a TBD scripting language, whose primary, but not sole purpose, may be to specify the order for which Vehicle Subdomains are programmed within a particular Vehicle Domain. That is, it may be this script that specifies the order the Vehicle Subdomain programming scripts specified herein are executed.

One ecosystem may use and augments the existing verification & validation EI certification system of a Vehicle OEM in order to organize, maintain, and subsequently distribute EIs across ECUs within a specific vehicle regardless of ECU type so long as the ECU manufacturer provides a specific minimum set of information regarding each EI within the an associated ECU, including specific relationship information with regard to V&V and releases between the ECU EIs. This may be required for all EIs within all ECUs that are to participate within a CarSync Configuration Management & Delivery Eco-System. Specific information required by one ecosystem for each ECU EI/ECU pair may be as follows: Each EI may have a unique release number that allows an iteration of the EI to always be identified, referenced, and differentiated from other prior or subsequent EI iterations; An absolute offset of each EI image in ECU memory; A UDS script that controls and specifies the downloading sequence of a specific EI into the specific ECU. This script more than likely includes the absolute offset referenced herein.

Additional features may relate to: An EI may or may not be transmitted from the Cloud Server without being encapsulated by a Release Package Wrapper; A Differential Release Package only contains those individual elements within the Release Package that are physically different than the immediate prior version of the same Release Package.

Non-Primary ECU Update Process—certain systems and methods take UDS Download Scripts that enable an external device to both all the ECUs on a given CAN bus (or other physical medium within the vehicle) network and download code to a specific ECU. Such scripts may be used by external devices that are connected to the car via a diagnostic port. Logic that runs these scripts may be moved into an existing MASTER ECU. Tier 1 ECU manufacturers may provide these scripts to the OEMs so that they can have their diagnostic equipment manufacturers utilize these scripts for updating ECUs in the field and in the repair centers. Additionally, and in order for these scripts to be effective, the ECUs may have hooks all the down into the Boot Loader code that allows this mechanism to operate and take control of the ECU at the most basic level.

Primary ECU Update Process—This may be the process that updates the “Master ECU”. The Master ECU may be the device being used to program all of the other ECUs. Thus, unlike when it may be updating “other” subordinate ECUs, when it updates itself, it does not have to utilize an external network to update itself. Compared to scripts from a non-primary ECU scripts, certain scripts may take advantage of the fact that the Master ECU may ALWAYS maintain the more two recent COMPLETE versions of core software Release Package. Thus, it can update itself in real time without affecting the existing Release Package since it can overwrite the “OLD” (or “alternate”) copy without adversely affecting the current (or “primary”) copy.

### Additional Aspects in Certain Embodiments

FIGS. 1-10 and 28A-B each illustrate different aspects of the disclosure, including system configurations and process flows.

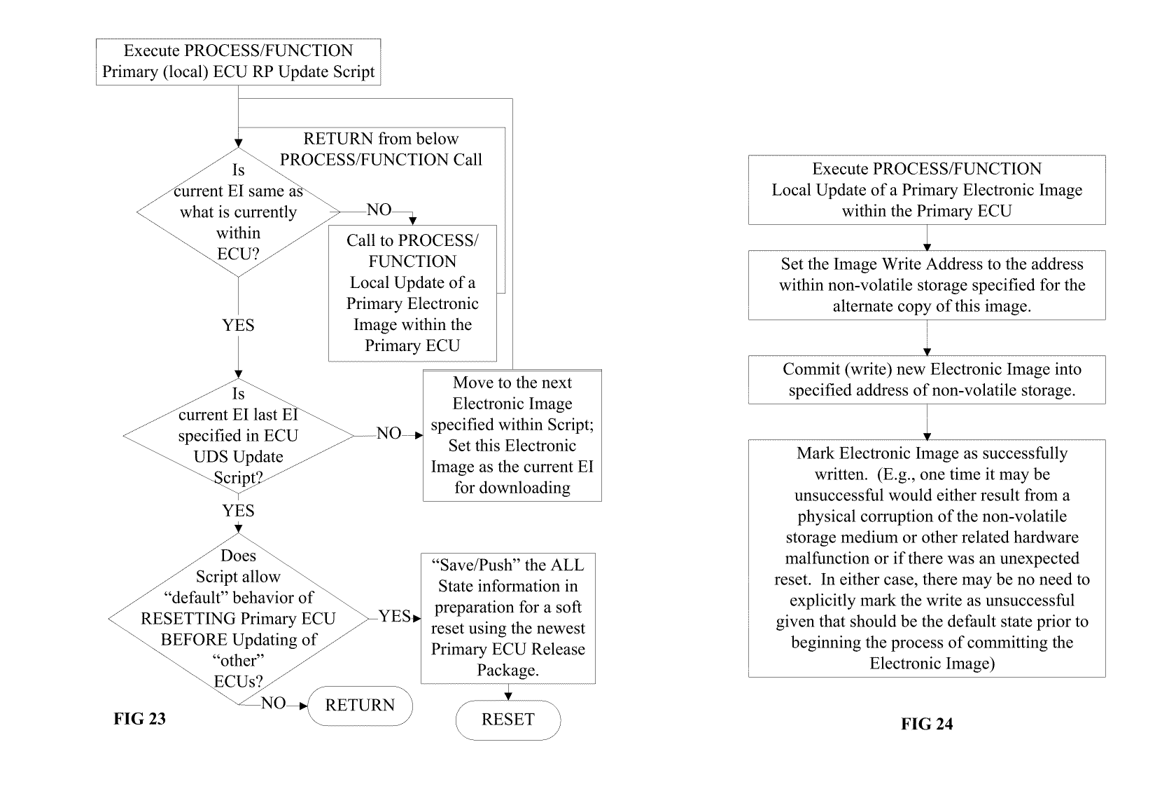

FIG. 23 illustrates an example process flow for executing a script associated with the Primary ECU. For example, the first Electronic Image may be specified within the Programming Script as the current EI for downloading. The main function of this Script is to update the Primary ECU hardware with the core/fundamental Electronic Images required for the Primary ECU to run with full functionality. The Scripting language used for the Primary ECU RP Update may be a UDS script, or some other scripting language. This may also simply be a function call as part of the core functionality of the CarSync software solution within the Primary ECU. If the default behavior for what occurs AFTER the Primary ECU has successfully completed, then the Primary ECU will do a “Reset” as a “sanity check” to ensure the latest revision is viable prior to updating “other” subordinate ECU's. Otherwise, in the event of a failure of the latest revision to properly run upon system reset, the subordinate ECUs would then also need to be “restored” to their prior state as well. It is not so much a “safety check” as it is a potential time saver. The default behavior should be enabled if the Primary ECU is the VERY first ECU within the VSD RP Script.

FIG. 24 illustrates a low-level function call for writing to the area of non-volatile storage where the Electronic Images are kept (i.e. usually near the beginning of the non-volatile storage medium within a static offset and NOT part of a dynamic file system).

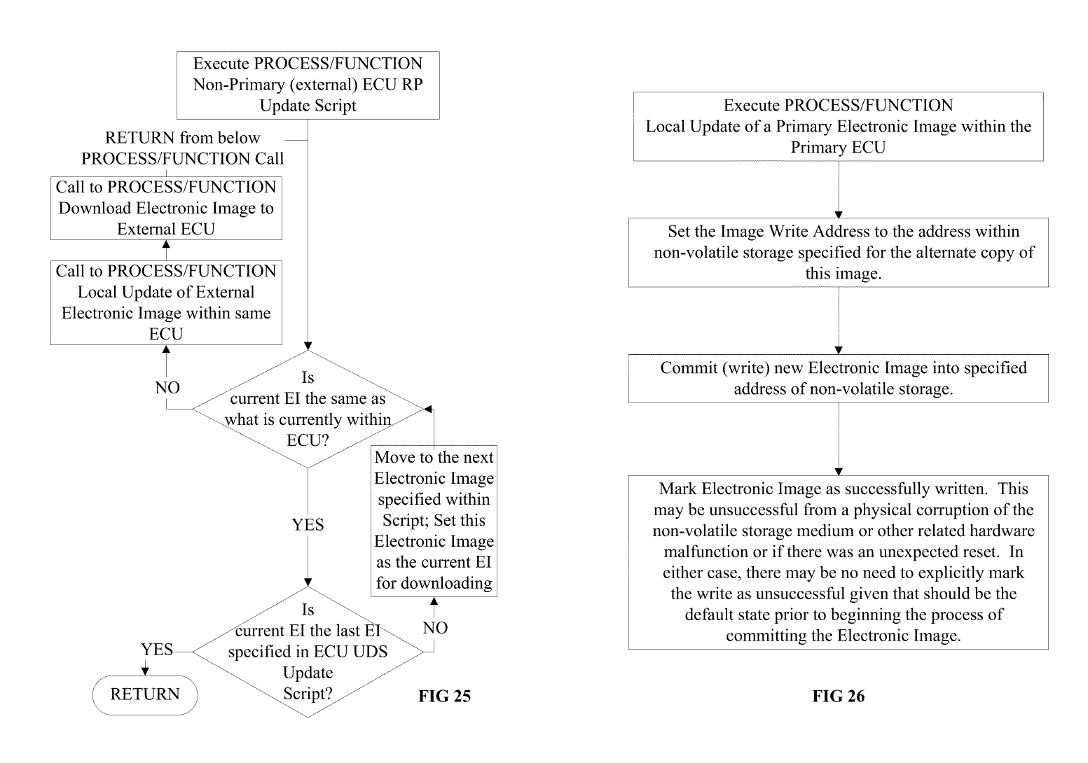

FIG. 25 illustrates a process flow for executing a Unified Diagnostic Service Script associated with the subordinate external ECU. The First Electronic Image may be specified within the UDS programming script as the current EI for downloading. The main function of this UDS script is to update the subordinate external ECU hardware with the core/fundamental Electronic Images required for the subordinate external ECU to run with full functionality.

FIG. 26 illustrates a low-level function call for writing to the area of non-volatile storage where the Electronic Images are kept (i.e. usually near the beginning of the non-volatile storage medium within a static offset and NOT part of a dynamic file system).

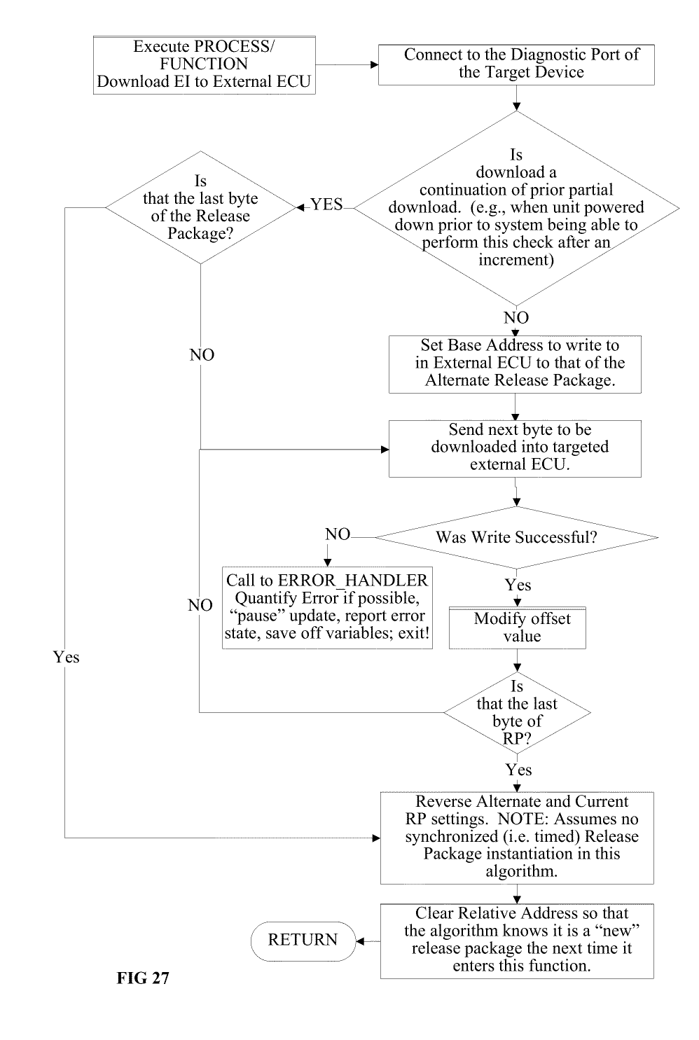

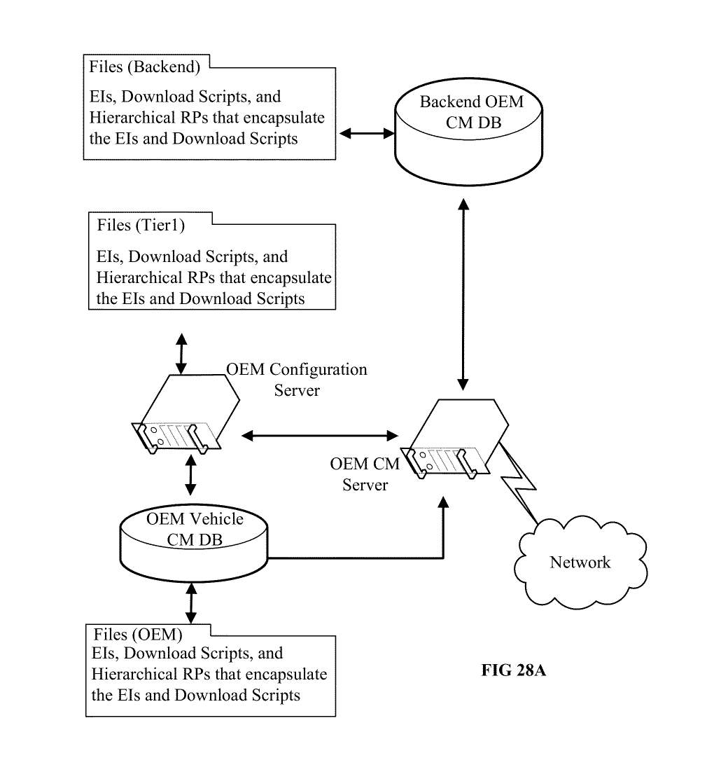

FIG. 27 illustrates a process flow for executing a UDS script to program the targeted ECU. This script accesses the downloaded Electronic Images and then transmits it to the target device (external ECU), which in turn the target device (i.e. targeted external ECU) saves it into its (the targeted external ECU's) memory. Unlike the Electronic Images of the Primary ECU, these Electronic Images may be maintained within the dynamic file system of the Primary ECU and used by the Primary ECU CarSync application image.

One aspect relates to vehicle accident or other event reporting. In accordance with this aspect, measurements may be taken of critical components within a vehicle, stored, and transferred. For example, a telematics/information vehicle subdomain may automatically notify authorities of a potential accident or catastrophic event. Various environmental inputs are contemplated, including deployment of airbag; sudden loss of air pressure in a tire; internal gyroscope detecting a hazardous angle or transition of car from one orientation to another; sudden loss of power to key components, while other components remain operational; and other inputs. Weights may be applied to the environmental inputs, and a notification may be issued when an overall weight exceeds a threshold level.

One aspect relates to a methodology that accesses the downloaded Electronic Images and then transmits it to the target device (external ECU), where the target device (i.e., targeted external ECU) saves it into its memory. The methodology, which is similar to the process flow shown in FIG. 27, performs the following first stage of steps: Connect to the Diagnostic Port of the Target Device., and determine if the download is a continuation of a prior partial download (i.e., is DownloadInProgressReleasePackageRelativeOffset>0; NOTE: This check may apply for the case in which the unit powered down prior it being able to do this check after an increment). If the download is not a continuation, set Base Address to write to in External ECU to that of the Alternate Release Package. (i.e., DownloadReleasePackageBaseOffset=ReleasePackageAbsoluteBaseOffset [AlternateReleasePackage]), and then proceed to the second stage of steps. Otherwise, if the download is a continuation, determine if the byte is the last byte of the Release Package (i.e., is DownloadReleasePackageRelativeOffset>=SizeInBytesOfNewReleasePackage). If not, go to the second stage of steps. If so, then go to an end stage of steps.

At the second stage of steps, a next byte is sent to be downloaded into a targeted external ECU (i.e., SuccessfulWrite=WriteByteIntoExternalNV_Storage (NewReleasePackage, DownloadReleasePackageBaseOffset, DownloadReleasePackageRelativeOffset)). A determination is made as to whether the write was successful (i.e., is SuccessfulWrite>0). If not, a call is made to ERROR_HANDLER to quantify the error if possible, pause the update, report error state, save off variables, and exit. If it was successful, a byte offset value is incremented (e.g., DownloadReleasePackageRelativeOffset++), and it is determined whether the byte was the last byte of the Release Package (i.e., DownloadReleasePackageRelativeOffset>=SizeInBytesOfNewReleasePackage). If not, the second stage of steps is repeated and the next byte is sent to be downloaded. Otherwise, if so, the methodology moves on to the end stage of steps. At the end stage of steps, release package settings are changed (i.e., AlternateReleasePackage=CurrentReleasePackage; CurrentReleasePackage=˜CurrentReleasePackage & 0xFE). NOTE: This may assumes no synchronized (i.e., timed) Release Package instantiation in this algorithm. A Relative Address may then be cleared so that the algorithm knows it is a “new” release package the next time it enters this function (i.e., DownloadReleasePackageRelativeOffset=0). Then the process ends.

One other aspect relate to a Proxy Server that determines the correct update for a particular car (or group of cars), and then communicates that update to the car(s) while the cars may communicate which byte is needed. For example, when a car pulls up, the server detects the car via some wireless communication exchange of information, the server determines what to deliver based on what the car specifies it needs, and the server determines where to start delivering (e.g., based on information sent from the car to the server). Multiple proxy servers may be geographically distinct, and independent of each other. Another aspect relates to pausing and resuming downloads of updates to vehicles from servers.

Additional aspects relate to recovery of corrupted images: (1) steps to identify corruption; (2) steps to recover and determine if image is missing key feature (e.g., using correlation techniques) or if execution of image is not providing recognized result. One “unique” features about this approach is a built-in system wide recovery mechanism with respect to corrupted images. The system may autonomously execute a self-recovery strategy, enabling it to re-instantiated itself into a consistent, known state, regardless of all but the most pervasive of corruptions.

Another aspect relates to an autonomous nature of recovery and self-management within the system (e.g., vehicle with system components). A master ECU may self-manage in a way to store and deliver updates to itself and other ECUs along with recovering from corruptions when/if needed. The ECU also does this in an intelligent manner monitors which elements of the system go with which ECU and cross checks not only EIs within each individual ECU, but also within the vehicle subdomain to which it belongs and the vehicle domain as a whole.

Other aspects may include: Embedding controlling functionality (i.e., the device controlling the unit being updated) directly within the vehicle and specifically within another ECU (e.g., a Telematics Control Unit or Head Unit); including a “network” of “Master ECUs,” each controlling their subnetwork of ECUs, with the TCU/EU being the controlling “Master” device (i.e., the Master of Masters if you will); dividing the content/configuration management system into internal vehicle subdomains; A vehicle itself potentially acting as a “Proxy Server” to other like vehicles in an M2M fashion; An agnostic nature of the approach with respect to either OEM or ECU (e.g., agnostic with respect to the hardware having a ubiquitous internal vehicle update solution that is neither directly dependent upon operating system nor ECU hardware); a Configuration Management infrastructure, including the types of fields necessary to organize (e.g., particularly with respect to anticipating V&V type of information as part of the rule based decisions for organizing the Release Packages); The ability for the vehicle to completely revert an entire vehicle release in the event of a catastrophic error to the previous version; Having database and distribution system within vehicle for self-recover; Take control and distribute within vehicle with disrupting simultaneous vehicle operation; and Partial download (to vehicle) and partial update/install (to internal location—monitor at distribution port to push when ready, monitor at receiver port to pull when available).

In accordance with one embodiment, the basic steps from the “inception” of a new Electronic Image to actual “deployment” of the new EI (and “other” required ancillary files and information) may be as follows: Tier 1 ECU Manufacturer updates one or more Electronic Images (EIs); Tier 1 ECU Manufacturer creates a new ECU Release Package (RP) based upon the updated EI(s); It is “assumed” that either the Tier 1 ECU Manufacturer collaborated with a third party test facility or did so themselves to verify that the new EIs did not degrade the interoperability functionality between itself and the other ECUs within a Vehicle Subdomain (recall, there are five classifications within the CarSync model of Vehicle Subdomains: (1) Powertrain; (2) Chassis; (3) Telematics & Infotainment; (4) Body Electronics & Cabin Comfort; and (5) Safety and Security); As a result of the above steps, in addition to the ECU Release Package (RP) created above, a Vehicle Subdomain Release Package will also be created by whoever is responsible for coordinating the interoperability functionality (If nothing else requires changing, this may be as simplistic as making a copy of the prior Vehicle Subdomain Release Package and substituting the NEW ECU Release Package in the place of the prior ECU Release Package in the most recent Vehicle Subdomain Release Package); Once there are “multiple” Vehicle Subdomains implemented, a new Vehicle Domain Release Package will also be required as a result of the updated EIs; All information listed in previous steps may be conveyed to the OEMs Configuration Database server; The OEM notifies the CarSync Backend Server of the updated EIs, RPs, and other associated information; The CarSync Backend Server processes/converts the updated EIs, Release Packages, and other associated information into the required format for downloading, processing, and distribution by the CarSync In-Vehicle Server (Part of the processing/conversion of the data sent to the CarSync Backend Server by the OEM Configuration Database Server will be to add additional information the CarSync In-Vehicle Backend Server & Distribution System it requires to complete its tasks. This may or may not require the CarSync Backend Server soliciting additional information from the OEM Configuration Database Server not originally sent to it.); The CarSync Backend Server will update its own internal cross reference list of Make/Model/Sub-model/Year and release package versions (This Cross Reference List is used in periodic broadcast/multi-cast transmissions at TBD intervals; notifying all delineable vehicle categories within its database of the most recently available update for each category; where a delineable vehicle category is defined to be, Make/Model/Sub-model/and Year.); The CarSync Backend Server will transmit out a “broadcast” or (preferred) a multicast notifying all affected vehicles that an updated set of releases is available to it; The CarSync Web-Services Client (WSC) interface receives both the Update Broadcast/Multicast from CarSync Backend Server as well as the periodic broadcasts/multicasts confirming most recent release information. It then conveys that information to the CarSync In-Vehicle Server for consideration; The CarSync In-Vehicle Server then determines if has the most up-to-date release packages (If so, nothing further needs to be done. If not, it then, according to its internal and personalized policy based configuration, decides whether or not to solicit the updates from the CarSync Backend Server.); If the CarSync In-Vehicle Server determines not to solicit the updates, then no further action is required. CarSync In-Vehicle Server determines that it desires to be updated, then it solicits through the Vehicle's Web-Services Client interface to the CarSync Backend Server for a session to begin specific to that particular vehicle; The CarSync In-Vehicle Server will initiate and continue attempting to contact the CarSync Backend Server until a valid session has been established and successfully completed, regardless of the number of attempts it might take; Once the CarSync In-Vehicle Server has established a virtual connection to the CarSync Backend Server, the Web-Services Client begins aggregating a download of only the actual EIs and other files within the updated Release Packages that are “different” from the files of the Release Package currently within the CarSync In-Vehicle Server.

The CarSync In-Vehicle Server's most recent Release Package may not be the same as the Release Package immediately prior to the Release Package being downloaded. Thus, the CarSync In-Vehicle Server may alert the CarSync Backend Server as to precisely which release it is currently using so that the CarSync Backend Server knows which files to send down. In truth, the CarSync Backend Server should already know exactly what the latest Release Package(s) the CarSync In-Vehicle Server is maintain, however, it may confirm this with the CarSync In-Vehicle Server rather than risk making an invalid assumption which could lead to catastrophic consequences if an incomplete Release Package was allowed to be distributed throughout the vehicle.

Once the files have been isolated that are different between the two Release Packages (i.e., the one to be downloaded and the most recent Release Package currently on the server; which may or may not be the active Release Package), a differential algorithm is utilized (i.e., Google's open-source Cougarette algorithm) to compute ONLY the differences between the affected files. Thus, ONLY the differentials are downloaded; saving both time and bandwidth.

Additional steps may include: The Web-Services Client aggregates the download until which time one of two events occurs (E.g., either the download completes or the download is interrupted for any one of a number of reasons including system power-down. In either case, the Web-Services Client remembers where the download stopped since the download was aggregating within a NV storage scratchpad and is capable of resuming the download precisely at the cessation point once the system is active again and the virtual connection reestablished.); Once the download has successfully completed, the aggregated differentials are first decrypted if necessary (i.e., if encryption was used) and then subsequently combined with their predecessors to formulate the new updated Electronic Images, Scripts, and other related differential files representing various elements detailed by a Release Package (The processed differentials and prior RP files are then validated against CRC, Checksum, and other integrity checks to ensure the new Release Packages and associated files are valid.); If the downloaded files fail any check, the entire process is repeated. Otherwise, the Web-Services Client notifies the CarSync In-Vehicle Server that a new RP (or set of RPs) is (are) ready for downloading; If the downloaded files pass all checks, then the CarSync In-Vehicle Server will begin processing the Release Package(s) for distribution to the appropriate (targeted) ECUs; There are three methodologies that can be utilized for the distribution phase of the EI Download & Distribution process (The chosen methodology is directly dependent upon “Policy Decisions” made by the OEM regarding how much memory it is willing to pay for within an ECU.)

In some cases, the primary ECU application does not execute from the same area of non-volatile storage from whence it is stored. If this is not the case, than the ECU may be placed in an quiescent state (non-operative) that allows the boot-loader and diagnostic stack to operate and process Diagnostic Commands (particularly those related to the download/update process). The Diagnostic Stack can operate whilst the primary application is also in operation. This implies that the Diagnostic Stack has been integrated into the primary application or if the subordinate ECU employs a Virtualization Software Architecture, then the Diagnostic Stack may run as a separate VM within the subordinate ECU.

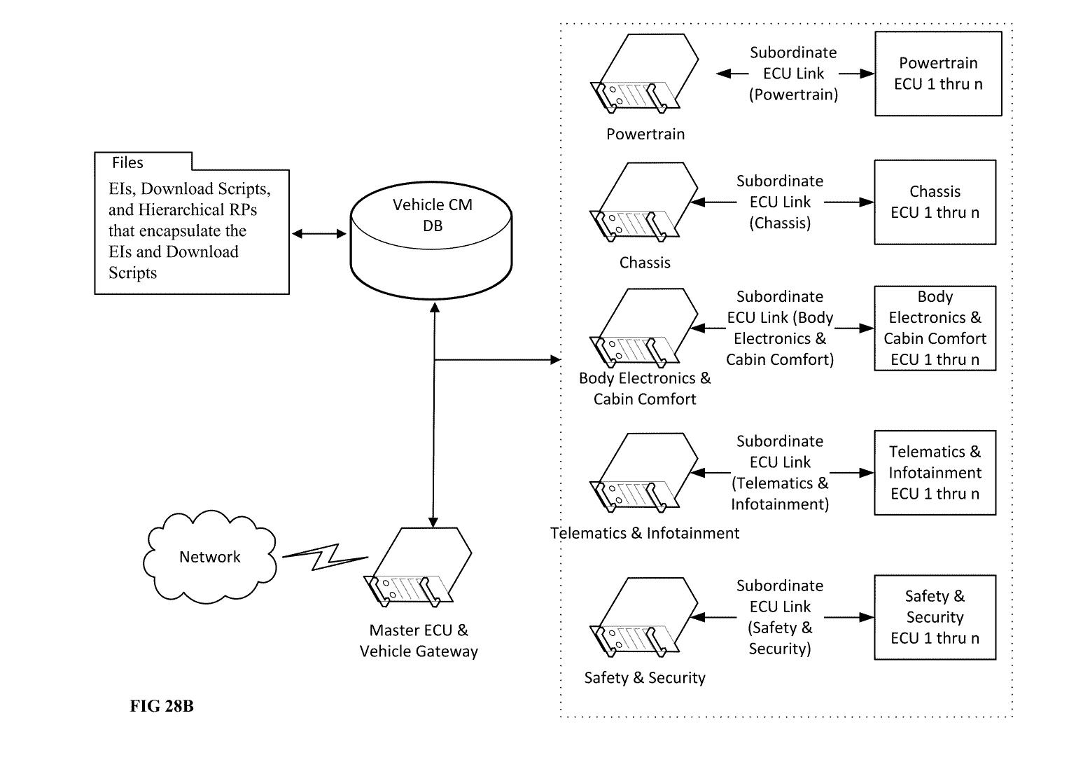

Attention is drawn to FIG. 28A. As shown, an OEM Configuration Server “builds” Hierarchical Release packages from the OEM Configuration Server using a combination of information obtained BOTH from the recently updated files sent from the Tier 1 as well as existing information already on the OEM Vehicle Configuration Management (CM) Relational database (DB). As, at a minimum, an updated image cannot be introduced without also validating all of the other images within the same ECU still work correctly. Additionally, the ECU will then need to be validated against “other” related ECUs within the same Vehicle Subdomain; thus a new Vehicle Subdomain Release Package will also be created even if nothing changed as a result of the newly acquired Images recently updated from the Tier 1.

The Tier 1 pushes electronic images and encapsulating release packages to OEM Configuration Server. The OEM Configuration Server notifies the backend Server it has updates. The backend server queries OEM VCM Relational DB for updated/new release packages, including EIs and associated scripts. Other ECU Release Package(s) and additional configuration management information such as V&V/QA Information may be stored in the files.

Attention is drawn to FIG. 28B. ECU Release Package(s) may include additional configuration management (CM) information such as V&V/QA information. The vehicle CM database (DB) may include 2-copies of ALL RPs of ECUs within Vehicle Subdomains.

### Summary Aspects in Certain Embodiments

Any of the various aspects described herein may be applied to mass distribution of software updates in a non-motorized vehicle setting. Various computer networks may benefit from implementation of the disclosed aspects within their networks to update disjoint, heterogeneous electronic control units. For example, various aspects may be used in conjunction with factories or smart utilities (e.g., transformers and other remotely located power equipment) to distribute updates to and from different parts of the network where various network components can distribute and receive updates (e.g., where a transformer obtains software updates from one or more nearby or passing cars at different times).

In accordance with at least one aspect, an automotive electronic system of a first motorized vehicle is configured to receive data transmitted from one or more external sources over an aggregate time period, wherein the data includes a first amount of data received during a first time period of the aggregate time period, and further includes a second amount of the data received during a second time period of the aggregate time period. The system may comprise one or more processing components operable to: request the first amount of data (e.g., one of many bytes of data) upon determining that the first amount of data has not been received by the first motorized vehicle; determine, after requesting the first amount of data, whether the first motorized vehicle received the first amount of data from the one or more external sources (e.g., by checking a downloaded byte offset value that identifies either the last downloaded byte or the next byte to be downloaded based on the byte number); request the second amount of data (e.g., a subsequent byte of data) when the first motorized vehicle received the first amount of data; determine, after requesting the second amount of data, whether the first motorized vehicle received the second amount of data from the one or more external sources; determine, when the first motorized vehicle received the second amount of data, whether one or more other amounts of the data exist; and determine, when the one or more other amounts of the data exist, whether the first motorized vehicle received the one or more other amounts of the data from the one or more external sources.

The one or more processing components may be further operable to: determine that the first motorized vehicle did not receive the first amount of data when the first amount of data is not stored in a data storage component of the system; and determine that the first motorized vehicle received the first amount of data when the first amount of data is stored in the data storage component of the system.

The one or more processing components may be further operable to: determine that the first motorized vehicle did not receive the first amount of data when a first condition at the first motorized vehicle is met; and determine that the first motorized vehicle received the one or more other amounts of the data when a second condition at the first motorized vehicle is met.

The one or more processing components may be further operable to: determine that the first motorized vehicle received the first amount of data when a first condition at the first motorized vehicle is met during a first period of time; and determine that the first motorized vehicle did not receive the one or more other amounts of the data when a second condition at the first motorized vehicle is met during a second period of time.

The first period of time and the second period of time may be separated by a plurality of hours. The first period of time and the second period of time may be separated by a third time period defined by an amount of time during which the first motorized vehicle may be unable to receive the one or more other amounts of the data. The first period of time and the second period of time may be separated by a third time period defined by an amount of time during which the system may be powered down. The first period of time and the second period of time may be separated by a third time period defined by an amount of time during which the one or more external sources may be powered down. The first period of time and the second period of time may be separated by a third time period defined by an amount of time during which there may be no suitable communication pathway connecting the system to the one or more external sources. The first motorized vehicle may be located at a first location during first period of time and a second location during the second period of time.

The first amount of data may include a first byte of a plurality of bytes, the second amount of data includes a second byte of the plurality of bytes, and the plurality of bytes specify a software or firmware update for an electronic component of the automotive electronic system of the motorized vehicle.

The first amount of the data may be received from a first external source, and the second amount of the data may be received from a second external source The first external source and the second external source may be at geographically different locations.

The first amount of the data may be received using a first communication pathway, and the second amount of the data may be received using a second communication pathway The first and second communication pathways may be different.

The first and second communication pathways may be selected from the group pathway types consisting of a GPS pathway, a Wi-Fi pathway, a cellular pathway, a USB pathway, and a Bluetooth pathway, and wherein the first and second communication pathways may be different pathway types.

The first and second communication pathways may be selected from the group of pathway types consisting of a wireless pathway and a wired pathway, and wherein the first and second communication pathways may be different pathway types.

The first and second communication pathways may be selected from the group of pathway types consisting of a first communication pathway between the first motorized vehicle and a moving motorized vehicle, a second communication pathway between the first motorized vehicle and a stationary motorized vehicle, a third communication pathway between the first motorized vehicle and a fixed transmitter, a fourth communication pathway between the first motorized vehicle and a portable computing device operated by a user, and a fifth communication pathway between the first motorized vehicle and a local area network, and wherein the first and second communication pathways may be different pathway types.

The first motorized vehicle may be further configured to simultaneously receive a third amount of the data using a third communication pathway and the first amount of data using the first communication pathway The first and third communication pathways may be of different types of pathways selected from the group pathway types consisting of a GPS pathway, a Wi-Fi pathway, a cellular pathway, a USB pathway, and a Bluetooth pathway.

The first and third amounts of data include data associated with a software or firmware update for an electronics control unit of the automotive electronic system. During the simultaneous download, each electronics control unit may process an identifier for discrete update data to determine which update may be intended for the vehicle of that control unit. For example, the electronic control units may interpret header information of each update to confirm whether the update applies to that electronic control unit's vehicle (e.g., the header may include some or all of the vehicle's VIN). Alternatively, distribution of the same update may be made to a group of vehicles so no processing may be needed or a header or other identifier.

The first amount of data includes data associated with a first software or firmware update for a first electronics control unit of the automotive electronic system, and the third amount of data includes data associated with a third software or firmware update for a third electronics control unit of the automotive electronic system.

The first and second amounts of the data both include data associated with a software or firmware update for an electronics control unit of the automotive electronic system.

The first amount of data specifies a software or firmware update for an electronic component of a second motorized vehicle The automotive electronic system further comprises: an output configured to transmit the first amount of data to the second motorized vehicle.

The data may represent an update to software or firmware used by an electronics control unit of the automotive electronic system, and the one or more processing components may be further operable to: cause the electronics control unit or a another one or more processing components connected to the electronics control unit to replace a portion of the software or firmware used by the ECU with the update; cause a data source to maintain a copy of the portion of the software or firmware used by the ECU that may be replaced by the update; and upon detecting that the update may be corrupted or that operation of the electronics control unit associated with the update provides an undesired result, replace the update with the portion of the software or firmware stored in the data source.

The one or more processing components may be further operable to: detect that the update may be corrupted by determining that the update may be missing data.

The one or more processing components may be further operable to: detect that operation of the electronics control unit associated with the update provides an undesired result by correlating the undesired result to a desired result.

In accordance with at least one aspect, a system for transmitting software/firmware updates to one or more motorized vehicles using one or more communication pathways may comprise one or more processing components operable to: detect, during a first period of time, a first motorized vehicle at a first location within a first range of a first communication pathway; determine a first portion of data representing a first software/firmware update to transmit to the first motorized vehicle; and causing the transmission of the first portion of the data through the first communication pathway during the first period of time.

The one or more processing components may be further operable to: detect the first motorized vehicle at the first location within a second range of a second communication pathway; determine a second portion of the data representing the first software/firmware update to transmit to the first motorized vehicle; and causing the transmission of the second portion of the data to the first motorized vehicle through the second communication pathway. The transmissions of the first and second portions of the data may be simultaneous.

The first and second communication pathways may be selected from the group pathway types consisting of a GPS pathway, a Wi-Fi pathway, a cellular pathway, a USB pathway, and a Bluetooth pathway, and wherein the first and second communication pathways may be different pathway types.

The first and second communication pathways may be selected from the group of pathway types consisting of a wireless pathway and a wired pathway, and wherein the first and second communication pathways may be different pathway types.

The first and second communication pathways may be selected from the group of pathway types consisting of a first communication pathway between the first motorized vehicle and a moving motorized vehicle, a second communication pathway between the first motorized vehicle and a stationary motorized vehicle, a third communication pathway between the first motorized vehicle and a fixed transmitter, a fourth communication pathway between the first motorized vehicle and a portable computing device operated by a user, and a fifth communication pathway between the first motorized vehicle and a local area network, and wherein the first and second communication pathways may be different pathway types.

The one or more processing components may be further operable to: detect, during a second period of time, the first motorized vehicle at a second location within a second range of a second communication pathway The first and second locations may be remote from each other; determine a second portion of the data to transmit to the first motorized vehicle; and causing the transmission of the second portion of the data to the first motorized vehicle through the second communication pathway during the second period of time.

The first and second communication pathways may be selected from the group pathway types consisting of a GPS pathway, a Wi-Fi pathway, a cellular pathway, a USB pathway, and a Bluetooth pathway, and wherein the first and second communication pathways may be different pathway types.

The first and second communication pathways may be selected from the group of pathway types consisting of a wireless pathway and a wired pathway, and wherein the first and second communication pathways may be different pathway types.

The first and second communication pathways may be selected from the group of pathway types consisting of a first communication pathway between the first motorized vehicle and a moving motorized vehicle, a second communication pathway between the first motorized vehicle and a stationary motorized vehicle, a third communication pathway between the first motorized vehicle and a fixed transmitter, a fourth communication pathway between the first motorized vehicle and a portable computing device operated by a user, and a fifth communication pathway between the first motorized vehicle and a local area network, and wherein the first and second communication pathways may be different pathway types.

The one or more processing components may be further operable to: detect a second motorized vehicle within a second range of a second communication pathway; determine a second portion of data representing a second software/firmware update to transmit to the second motorized vehicle; and cause the transmission of the second portion of the data to the second motorized vehicle through the second communication pathway.

The transmissions of the first and second portions of the data may be simultaneous. The first and second communication pathways may be selected from the group pathway types consisting of a GPS pathway, a Wi-Fi pathway, a cellular pathway, a USB pathway, and a Bluetooth pathway, and wherein the first and second communication pathways may be different pathway types.

The first and second communication pathways may be selected from the group of pathway types consisting of a wireless pathway and a wired pathway, and wherein the first and second communication pathways may be different pathway types.

The first and second communication pathways may be selected from the group of pathway types consisting of a first communication pathway between the first motorized vehicle and a moving motorized vehicle, a second communication pathway between the first motorized vehicle and a stationary motorized vehicle, a third communication pathway between the first motorized vehicle and a fixed transmitter, a fourth communication pathway between the first motorized vehicle and a portable computing device operated by a user, and a fifth communication pathway between the first motorized vehicle and a local area network, and wherein the first and second communication pathways may be different pathway types.

The one or more processing components may be further operable to: detect the second motorized vehicle within the second range of a second communication pathway during the first period of time. The one or more processing components may be further operable to: detect the second motorized vehicle within the second range of a second communication pathway during a second period of time. The one or more processing components may be further operable to: detect the second motorized vehicle at the first location. The one or more processing components may be further operable to: detect the second motorized vehicle at a second location The first and second locations may be remote from each other.

In accordance with another aspect, a method for receiving data specifying a software or firmware update for an electronic component of an motorized vehicle from an external source may perform the following steps: determining, during a first time period, if a first amount of the data may be stored in a data source of the motorized vehicle; requesting, when the first amount of the data may be not stored in the data source, the first amount of the data; receiving, after the first amount of data may be requested, the first amount of data; storing, after receiving the first amount of data, the first amount of data in the data source; determining, after the first amount of the data may be stored in the data source, if all of the data may be stored in the data source; requesting, when all of the data may be not stored in the data source and when the first amount of the data may be stored in the data source, a second amount of the data; receiving, when the second amount of data may be requested, the second amount of data; and storing, after receiving the second amount of data, the second amount of data in the data source, wherein at least one or more processing components performs at least one of the above steps.

The determining if the first amount of the data may be stored in the data source of the motorized vehicle may comprise any of the steps of: determining that the first amount of data may be stored in the data source when a first threshold condition may be met; determining that all of the data may be stored in the data source when a second threshold condition may be met during the first time period; and determining that all of the data may be stored in the data source when a second threshold condition may be met during a second time period.

### Other Aspects

The various illustrative systems, methods, logical blocks, modules, circuits, and algorithm steps described herein may be implemented or performed directly in hardware, in software executed by a processor (also referred to as a “processing device”), or in a combination of the two. Accordingly, a processor may perform any one, some or all of the processing, computational and other method steps or other system functionality relating to the processes/methods and systems disclosed herein. Such processors may include a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor can also refer to a chip, where that chip includes various components (e.g., a microprocessor and other components) that are configured to carry out any of the processing, computational and other method steps disclosed herein in addition to other functionality disclosed herein. The term “processor” may refer to one, two or more such devices. Furthermore, a processor may be implemented as a combination of processors (e.g., a combination of a DSP and a microprocessor), multiple microprocessors, a microprocessor in conjunction with a DSP core, or any other such configuration. It is noted that the terms “computer” or “computing device” or the like may refer to devices that include a processor.

Software may reside in RAM memory, flash memory, ROM memory, EPROM memory, EEPROM memory, registers, hard disk, a removable disk, a CD-ROM, or any other form of storage medium known in the art. An exemplary storage medium is “memory” coupled to a processor such that the processor can read information from, and write information to, the memory. In the alternative, the storage medium may be integral to the processor. The processor and the storage medium may reside in an ASIC. The ASIC may reside in a user device. In the alternative, the processor and the storage medium may reside as discrete components in a user device.

Software may be stored on or encoded as one or more instructions or code on a computer-readable medium. Computer-readable media includes computer storage media which may be any available media that can be accessed by a computer. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include transfers (uploads, downloads, e-mail, etc.) over the Internet and/or other computer networks via one or more data transfer protocols known or later developed in the art. When received within a computer system via one or more computer-readable media, such data and/or instruction-based expressions of the components may be processed by a processor (e.g., one or more processors) within a computer system in conjunction with execution of one or more other computer programs.

Aspects of systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the systems and methods include microcontrollers with memory (such as electronically erasable programmable read only memory (EEPROM)), embedded microprocessors, firmware, software, and the like. Aspects of systems and methods may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, and the like. Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Aspects of the present disclosure are typically carried out in or resident on a computing network. The computing network generally includes computer hardware components such as servers, monitors, I/O devices, network connection devices, as well as other associated hardware. In addition, the aspects and features described herein may include one or more application programs configured to receive, convert, process, store, retrieve, transfer and/or export data and other content and information. Data may be stored on any number of data sources that may be a hard disk drive or other storage media. A data source may include one or more types of a data sources, including hierarchical data sources, network data sources, relational data sources, non-relational data sources, object-oriented data sources, or another type of data source able to handle various data types (e.g., structured data that fits nicely into fields, rows, and columns, or data from various media sources such as graphics, photographs, audio, and video structured data. For example, the data source 132 may store data in a fixed file format, such as XML, comma separated values, tab separated values, or fixed length fields. Alternatively, the data source may store data in a non-fixed file format (e.g., a NoSQL data source). The term “database” may refer to any data source.

Unless the context clearly requires otherwise, throughout the description and the claims, the words “comprise,” “comprising,” “include,” “including” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import, when used in this application, refer to this application as a whole and any incorporated references. When the words “or” or “and” are used in reference to a list of two or more items, each of those words cover all of the following interpretations: any of the items in the list, all of the items in the list, and any combination of the items in the list. Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. Figures and associated description are provided for illustration, and it is to be understood that parts of any number or all figures may be rearranged, omitted, or combined. Moreover, a computation shown at one device may be performed across various devices. The term “system” may refer to one or more devices that may be geographically remote from each other. The term “device” may comprise one or more components (e.g., a processor, a memory, a screen). The term “module” may refer to hardware or software.

Description herein of systems and methods is not intended to be exhaustive or to limit the systems and methods to the precise forms disclosed. Indeed, systems and methods are described herein for illustrative purposes, and various equivalent modifications are possible as those skilled in the art will recognize. Terms used in the claims are not to be limited to only the embodiments disclosed expressly herein. Instead, those terms are to receive their broadest interpretation. “Exemplary” means serving as an example, instance or illustration. Any aspect and/or embodiment described herein as “exemplary” is not to be construed as preferred or advantageous over other aspects and/or embodiments.

Various modifications to aspects disclosed herein will be readily apparent to those skilled in the art, and the generic principles defined herein may be applied to various systems and methods without departing from the spirit or scope of the disclosure. Thus, the disclosure is not intended to be limited to the aspects shown herein but is to be accorded the widest scope consistent with the appended claims and their equivalents.

1. A system configured to receive data transmitted from one or more external sources over an aggregate time period, wherein the data includes a first amount of data received during a first time period of the aggregate time period, and further includes a second amount of the data received during a second time period of the aggregate time period, the system comprising a first one or more processing components of an automotive electronic system of a first motorized vehicle that are operable to:
request, upon determining that the first amount of data has not been received by the first motorized vehicle, the first amount of data;
determine, after requesting the first amount of data, whether the first motorized vehicle received the first amount of data from the one or more external sources;
request, when the first motorized vehicle received the first amount of data, the second amount of data;
determine, after requesting the second amount of data, whether the first motorized vehicle received the second amount of data from the one or more external sources;
determine, when the first motorized vehicle received the second amount of data, whether one or more other amounts of the data exist; and
determine, when the one or more other amounts of the data exist, whether the first motorized vehicle received the one or more other amounts of the data from the one or more external sources.

2. The system of claim 1, wherein the first one or more processing components is further operable to:
determine that the first motorized vehicle did not receive the first amount of data when the first amount of data is not stored in a data storage component of the system; and
determine that the first motorized vehicle received the first amount of data when the first amount of data is stored in the data storage component of the system.

3. The system of claim 1, wherein the first one or more processing components is further operable to:
determine that the first motorized vehicle did not receive the first amount of data when a first condition at the first motorized vehicle is met; and
determine that the first motorized vehicle received the one or more other amounts of the data when a second condition at the first motorized vehicle is met.

4. The system of claim 1, wherein the first one or more processing components is further operable to:
determine that the first motorized vehicle received the first amount of data when a first condition at the first motorized vehicle is met during a first period of time; and
determine that the first motorized vehicle did not receive the one or more other amounts of the data when a second condition at the first motorized vehicle is met during a second period of time.

5. The system of claim 1, wherein the first amount of data includes a first byte of a plurality of bytes, the second amount of data includes a second byte of the plurality of bytes, and the plurality of bytes specify a software or firmware update for an electronic component of the automotive electronic system of the motorized vehicle.

6. The system of claim 1, wherein the first amount of the data is received from a first external source, and the second amount of the data is received from a second external source, wherein the first external source and the second external source are at geographically different locations.

7. The system of claim 1, wherein the first amount of the data is received using a first communication pathway, and the second amount of the data is received using a second communication pathway, wherein the first and second communication pathways are different.

8. The system of claim 1, wherein the first motorized vehicle is further configured to simultaneously receive a third amount of the data using a third communication pathway and the first amount of data using the first communication pathway, wherein the first and third communication pathways are of different types of pathways selected from the group pathway types consisting of a GPS pathway, a Wi-Fi pathway, a cellular pathway, a USB pathway, and a Bluetooth pathway.

9. The system of claim 8, wherein the first and third amounts of data include data associated with a software or firmware update for an electronics control unit of the automotive electronic system.

10. The system of claim 8, wherein the first amount of data includes data associated with a first software or firmware update for a first electronics control unit of the automotive electronic system, and the third amount of data includes data associated with a third software or firmware update for a third electronics control unit of the automotive electronic system.

11. The system of claim 1, wherein the first and second amounts of the data both include data associated with a software or firmware update for an electronics control unit of the automotive electronic system.

12. The system of claim 1, wherein the first amount of data specifies a software or firmware update for an electronic component of a second motorized vehicle, wherein the automotive electronic system further comprises:
an output configured to transmit the first amount of data to the second motorized vehicle.

13. The system of claim 1, wherein the data represents an update to software or firmware used by an electronics control unit of the automotive electronic system, and wherein the first one or more processing components is further operable to:
cause the electronics control unit or a another first one or more processing components connected to the electronics control unit to replace a portion of the software or firmware used by the ECU with the update;
cause a data source to maintain a copy of the portion of the software or firmware used by the ECU that is replaced by the update; and
upon detecting that the update is corrupted or that operation of the electronics control unit associated with the update provides an undesired result, replace the update with the portion of the software or firmware stored in the data source.

14. The system of claim 13, wherein the first one or more processing components is further operable to:
detect that the update is corrupted by determining that the update is missing data.

15. The system of claim 13, wherein the first one or more processing components is further operable to:
detect that operation of the electronics control unit associated with the update provides an undesired result by correlating the undesired result to a desired result.

16. The system of claim 4, wherein the first period of time and the second period of time are separated by a third time period defined by an amount of time during which the first motorized vehicle is unable to receive the one or more other amounts of the data, or during which the system is powered down.

17. The system of claim 4, wherein the first motorized vehicle is located at a first location during first period of time and a second location during the second period of time.

18. The system of claim 7, wherein the first and second communication pathways are selected from the group of pathway types consisting of a first communication pathway between the first motorized vehicle and a moving motorized vehicle, a second communication pathway between the first motorized vehicle and a stationary motorized vehicle, a third communication pathway between the first motorized vehicle and a fixed transmitter, a fourth communication pathway between the first motorized vehicle and a portable computing device operated by a user, and a fifth communication pathway between the first motorized vehicle and a local area network, and wherein the first and second communication pathways are different pathway types.

19. The system of claim 1, further comprising a second one or more processing components remote from the first motorized vehicle that are operable to:
detect, during a first period of time, the first motorized vehicle at a first location within a first range of a first communication pathway;
determine the first amount of data representing a first software/firmware update to transmit to the first motorized vehicle; and
causing the transmission of the first portion of the data through the first communication pathway during the first period of time.
